(19) United States
(12) Patent Application Publication
(10) Pub. No.: US 2025/0174240 A1
(43) Pub. Date: May 29, 2025

(54) QUANTIZATION METHOD, DEQUANTIZATION METHOD, AND APPARATUS THEREOF

(71) Applicant: HUAWEI TECHNOLOGIES CO., LTD., Shenzhen (CN)

(72) Inventors: Zhuo Wang, Shenzhen (CN); Bin Feng, Shenzhen (CN); Chunhui Du, Shenzhen (CN); Fan Fan, Shenzhen (CN)

(73) Assignee: HUAWEI TECHNOLOGIES CO., LTD., Shenzhen (CN)

(21) Appl. No.: 19/035,998

(22) Filed: Jan. 24, 2025

Related U.S. Application Data
(63) Continuation of application No. PCT/CN2023/092043, filed on May 4, 2023.

(30) Foreign Application Priority Data
Jul. 27, 2022 (CN) 202210892838.0
Sep. 19, 2022 (CN) 202211139939.7

(51) Int. Cl. G10L 19/032; G10L 19/02

(52) U.S. Cl. CPC G10L 19/032; G10L 19/0204

(57) ABSTRACT

A quantization method is disclosed. The method includes obtaining a psychoacoustic spectrum envelope coefficient of each sub-band based on a scale factor of each sub-band and a target bit depth for encoding an audio signal, determining, based on the psychoacoustic spectrum envelope coefficient of the sub-band, a target spectrum value that needs to be quantized in the sub-band, where a first total quantity of bits consumed by the target spectrum value in an encoded frame is less than or equal to a quantity of available bits of each frame of signal, and the quantity of available bits is determined based on a target bit rate that can be used by an encoder side to transmit the audio signal to a decoder side, and obtaining a quantized value of the target spectrum value based on the target spectrum value.

### CROSS-REFERENCE TO RELATED APPLICATIONS

This application is a continuation of International Application No. PCT/CN2023/092043, filed on May 4, 2023, which claims priority to Chinese Patent Application No. 202210892838.0, filed on Jul. 27, 2022 and Chinese Patent Application No. 202211139939.7, filed on Sep. 19, 2022. All of the afore-mentioned patent applications are hereby incorporated by reference in their entireties.

### TECHNICAL FIELD

The present disclosure relates to the field of audio signal processing technologies, and in particular, to a quantization method, a dequantization method, and apparatuses thereof.

### BACKGROUND

As quality of life improves, people's requirements on high-quality audio are increasing. To better transmit an audio signal on a limited bandwidth, data compression usually needs to be performed on the audio signal at an encoder side first, and then a compressed bitstream is transmitted to a decoder side. The decoder side performs decoding processing on the received bitstream to obtain a decoded audio signal, and the decoded audio signal is for playback.

However, in a transmission process of the audio signal, a throughput and stability of a connection between an audio sending device and an audio receiving device greatly affect quality of the audio signal. For example, data shows that all codecs are affected when a received signal strength indication (received signal strength indication, RSSI) of Bluetooth connection quality is below −80 (decibel milliwatt, dBm). However, for a Bluetooth codec, when Bluetooth connection quality is severely interfered, if bit rates fluctuate greatly, a duty cycle of the signal sent by the audio sending device to the audio receiving device is high. As a result, a packet loss and discontinuity are likely to occur, causing severe deterioration of subjective listening experience of human ears. Therefore, ensuring stability of the bit rate in the transmission process is a technical problem that needs to be urgently resolved in a Bluetooth short-range scenario or the like.

### SUMMARY

The present disclosure provides a quantization method, a dequantization method, and apparatuses thereof, to help maintain a bit rate of each frame in a constant state based on a target bit rate, improve stability of the bit rate in a transmission process, and further improve anti-interference performance of an encoded bitstream for sending an audio signal. The technical solutions are as follows.

According to a first aspect, the present disclosure provides a quantization method. The method is applied to an encoder side, and the method includes: obtaining a psychoacoustic spectrum envelope coefficient of each sub-band based on a scale factor of each sub-band and a target bit depth for encoding an audio signal; determining, based on the psychoacoustic spectrum envelope coefficient of the sub-band, a target spectrum value that needs to be quantized in the sub-band, where a first total quantity of bits consumed by the target spectrum value in an encoded frame is less than or equal to a quantity of available bits of each frame of signal, and the quantity of available bits is determined based on a target bit rate that can be used by an encoder side to transmit the audio signal to a decoder side; and obtaining a quantized value of the target spectrum value based on the target spectrum value.

In the quantization method provided in the present disclosure, the psychoacoustic spectrum envelope coefficient of each sub-band is obtained based on the target bit depth for encoding the audio signal and the scale factor of each sub-band; the target spectrum value that needs to be quantized in the sub-band is determined based on the psychoacoustic spectrum envelope coefficient of the sub-band; and then the quantized value of the target spectrum value is obtained based on the target spectrum value, where the first total quantity of bits consumed by the target spectrum value in the encoded frame is less than or equal to the quantity of available bits of each frame of signal, and the quantity of available bits is determined based on the target bit rate that can be used by the encoder side to transmit the audio signal to the decoder side. It can be learned from the descriptions of the present disclosure that, the quantization method actually indicates a process of performing bit allocation based on the target bit rate, so as to control quantization precision based on the target bit rate. In addition, the process is implemented by adjusting the psychoacoustic spectrum envelope coefficient of the sub-band, and performing masking guide on the spectrum value in the sub-band based on the psychoacoustic spectrum envelope coefficient. Therefore, quantization is performed according to the quantization method, to help maintain a bit rate of each frame in a constant state based on the target bit rate, improve stability of the bit rate in a transmission process, and further improve anti-interference performance of an encoded bitstream for sending the audio signal.

In an implementation, the determining, based on the psychoacoustic spectrum envelope coefficient of the sub-band, a target spectrum value that needs to be quantized in the sub-band includes: determining, based on the psychoacoustic spectrum envelope coefficient of the sub-band, a psychoacoustic spectrum for masking a spectrum of the audio signal; obtaining, from a spectrum value of the audio signal, a to-be-determined spectrum value that is in the sub-band and that is not masked by the psychoacoustic spectrum; and determining, based on the to-be-determined spectrum value, the target spectrum value that needs to be quantized in the sub-band.

Optionally, the determining, based on the to-be-determined spectrum value, the target spectrum value that needs to be quantized in the sub-band includes: obtaining a second total quantity of bits consumed by the to-be-determined spectrum value in the encoded frame; when the second total quantity of bits is less than or equal to the quantity of available bits of each frame of signal, determining the to-be-determined spectrum value as the target spectrum value; and when the second total quantity of bits is greater than the quantity of available bits of each frame of signal, adjusting the psychoacoustic spectrum envelope coefficient of the sub-band, and determining, based on an adjusted psychoacoustic spectrum envelope coefficient, a second total quantity of bits consumed by the to-be-determined spectrum value in the encoded frame, until the second total quantity of bits that is consumed by the to-be-determined spectrum value in the encoded frame and that is determined based on the adjusted psychoacoustic spectrum envelope coefficient is less than or equal to the quantity of available bits of each frame of signal; and determining the to-be-determined spectrum value as the target spectrum value; and
the adjusting the psychoacoustic spectrum envelope coefficient of the sub-band, and determining, based on an adjusted psychoacoustic spectrum envelope coefficient, a second total quantity of bits consumed by the to-be-determined spectrum value in the encoded frame includes: adjusting the psychoacoustic spectrum envelope coefficient of the sub-band in the audio signal in a first adjustment manner; updating the to-be-determined spectrum value based on the adjusted psychoacoustic spectrum envelope coefficient; and obtaining, based on an updated to-be-determined spectrum value, the second total quantity of bits consumed by the updated to-be-determined spectrum value in the encoded frame.

Optionally, the first adjustment manner is obtained based on the target bit depth.

Optionally, the first adjustment manner indicates to increase the psychoacoustic spectrum envelope coefficient of the sub-band in the audio signal when the second total quantity of bits is greater than the quantity of available bits of each frame of signal.

Optionally, the first adjustment manner indicates to adjust a psychoacoustic spectrum envelope coefficient of a second sub-band in the audio signal after adjustment of a psychoacoustic spectrum envelope coefficient of a first sub-band in the audio signal is completed, and a frequency of the first sub-band is higher than a frequency of the second sub-band.

In an implementation, the obtaining a second total quantity of bits consumed by the to-be-determined spectrum value in the encoded frame includes: quantizing the to-be-determined spectrum value based on the psychoacoustic spectrum envelope coefficient of the sub-band to obtain a quantized value of the to-be-determined spectrum value; and obtaining a quantity of bits consumed by the encoder side to encode each quantized value of each frame of signal to obtain the second total quantity of bits.

Optionally, before the obtaining a second total quantity of bits consumed by the to-be-determined spectrum value in the encoded frame, the determining, based on the to-be-determined spectrum value, the target spectrum value that needs to be quantized in the sub-band further includes: estimating, based on the psychoacoustic spectrum envelope coefficient of the sub-band, a third total quantity of bits consumed by the to-be-determined spectrum value in the encoded frame; when a difference between the third total quantity of bits and the quantity of available bits of each frame of signal falls within a first threshold range, determining to execute a process of obtaining the second total quantity of bits consumed by the to-be-determined spectrum value in the encoded frame; and when the difference between the third total quantity of bits and the quantity of available bits of each frame of signal is outside of the first threshold range, adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determining to execute the process of obtaining the second total quantity of bits consumed by the to-be-determined spectrum value in the encoded frame; and
the adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame includes: adjusting the psychoacoustic spectrum envelope coefficient of the sub-band in the audio signal in a second adjustment manner; updating the to-be-determined spectrum value based on the adjusted psychoacoustic spectrum envelope coefficient; and obtaining, based on an updated to-be-determined spectrum value, the third total quantity of bits consumed by the updated to-be-determined spectrum value in the encoded frame.

In an implementation, the determining, based on the to-be-determined spectrum value, the target spectrum value that needs to be quantized in the sub-band includes: estimating, based on the psychoacoustic spectrum envelope coefficient of the sub-band, a third total quantity of bits consumed by the to-be-determined spectrum value in the encoded frame; when a difference between the third total quantity of bits and the quantity of available bits of each frame of signal falls within a first threshold range, determining the to-be-determined spectrum value as the target spectrum value; and when the difference between the third total quantity of bits and the quantity of available bits of each frame of signal is outside of the first threshold range, adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determining the to-be-determined spectrum value as the target spectrum value; and
the adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame includes: adjusting the psychoacoustic spectrum envelope coefficient of the sub-band in the audio signal in a second adjustment manner; updating the to-be-determined spectrum value based on the adjusted psychoacoustic spectrum envelope coefficient; and obtaining, based on an updated to-be-determined spectrum value, the third total quantity of bits consumed by the updated to-be-determined spectrum value in the encoded frame.

Optionally, the second adjustment manner is obtained based on the target bit depth.

Optionally, the second adjustment manner indicates to increase the psychoacoustic spectrum envelope coefficient of the sub-band in the audio signal when the third total quantity of bits is greater than the quantity of available bits of each frame of signal, or decrease the psychoacoustic spectrum envelope coefficient of the sub-band in the audio signal when the third total quantity of bits is less than the quantity of available bits of each frame of signal.

Optionally, the second adjustment manner indicates to adjust a psychoacoustic spectrum envelope coefficient of a fourth sub-band in the audio signal after adjustment of a psychoacoustic spectrum envelope coefficient of a third sub-band in the audio signal is completed, and a frequency of the third sub-band is higher than a frequency of the fourth sub-band.

In an implementation, the estimating, based on the psychoacoustic spectrum envelope coefficient of the sub-band, a third total quantity of bits consumed by the to-be-determined spectrum value in the encoded frame includes: obtaining, based on the psychoacoustic spectrum envelope coefficient of the sub-band, an average quantity of bits consumed by each spectrum value in the sub-band; obtaining, based on the average quantity of bits of the sub-band and a total quantity of spectrum values included in the sub-band, a fourth total quantity of bits consumed by the spectrum value in the sub-band; and obtaining the third total quantity of bits based on the fourth total quantity of bits consumed by the sub-band.

According to a second aspect, the present disclosure provides a quantization method. The method is applied to an encoder side, and the method includes: when a first total quantity of bits consumed by a target spectrum value in an encoded frame is less than a quantity of available bits of each frame of signal, determining, based on an importance degree of information represented by a spectrum value of an audio signal, a residual spectrum value that needs to be quantized in other spectrum values, where the other spectrum values are spectrum values other than the target spectrum value in spectrum values of the audio signal; obtaining a quantized value of the residual spectrum value based on the residual spectrum value; obtaining quantization indication information of the residual spectrum value based on the residual spectrum value, where the quantization indication information indicates a manner of dequantizing the residual spectrum value; and providing the quantization indication information for a decoder side.

In the quantization method, when the first total quantity of bits consumed by the target spectrum value in the encoded frame is less than the quantity of available bits of each frame of signal, the residual spectrum value that needs to be quantized is determined in another spectrum value based on the importance of the information represented by the spectrum value of the audio signal, and the quantized value of the residual spectrum value is obtained based on the residual spectrum value. This can effectively use a remaining bit, maintain a bit rate of each frame in a constant state based on the target bit rate, improve stability of the bit rate in a transmission process, and further improve anti-interference performance of an encoded bitstream for sending the audio signal.

In an implementation, the importance degree is indicated by a scale factor of a sub-band on which a frequency to which the spectrum value belongs is located.

In an implementation, the determining, based on an importance degree of information represented by a spectrum value of an audio signal, a residual spectrum value that needs to be quantized in other spectrum values includes: determining, in all sub-bands of the audio signal, a reference sub-band having a largest scale factor; determining, based on a distance from each sub-band other than the reference sub-band to the reference sub-band, weight of another spectrum value of the sub-band to be the residual spectrum value; and determining, in descending order of the weights, whether an another spectrum value of a corresponding sub-band is the residual spectrum value until a difference between a fifth total quantity of bits consumed by the target spectrum value and all the residual spectrum value in the encoded frame and the quantity of available bits of each frame of signal falls within a second threshold range, where when the another spectrum value of a sub-band is used as the residual spectrum value, if the fifth total quantity of bits consumed by the target spectrum value and all the determined residual spectrum values in the encoded frame is greater than the quantity of available bits of each frame of signal, neither the another spectrum value of the sub-band nor another spectrum value of another sub-band whose weight is less than or equal to a weight of the sub-band can be used as the residual spectrum value.

In an implementation, a weight of any sub-band is inversely correlated with a distance from the any sub-band to the reference sub-band.

In an implementation, a weight of a sub-band is further obtained based on a condition in which the sub-band is masked by a psychoacoustic spectrum, and a weight of a sub-band masked by the psychoacoustic spectrum is greater than a weight of a sub-band not masked by the psychoacoustic spectrum.

In an implementation, the obtaining quantization indication information of the residual spectrum value based on the residual spectrum value includes: performing rounding processing on the residual spectrum value; and determining, based on a residual spectrum value on which rounding processing is performed, a quantization manner for quantizing the residual spectrum value, to obtain the quantization indication information.

Optionally, the target spectrum value is determined according to the method provided in any one of the first aspect or the possible implementations of the present disclosure.

According to a third aspect, the present disclosure provides a dequantization method. The method is applied to a decoder side, and the method includes: receiving an encoded bitstream provided by an encoder side; obtaining, based on the encoded bitstream, an importance degree of information represented by a spectrum value of an audio signal; determining, based on the importance degree, a code value and quantization indication information of a residual spectrum value in the encoded bitstream, where the quantization indication information indicates a manner of dequantizing the residual spectrum value by the encoder side; and performing a dequantization operation on the code value of the residual spectrum value based on the quantization indication information of the residual spectrum value, to obtain a dequantized code value.

In the dequantization method, when a first total quantity of bits consumed by a target spectrum value in an encoded frame is less than a quantity of available bits of each frame of signal, a residual spectrum value that needs to be quantized is determined from another spectrum value based on the importance of the information represented by the spectrum value of the audio signal, and a quantized value of the residual spectrum value is obtained based on the residual spectrum value. This can effectively use a remaining bit, maintain a bit rate of each frame in a constant state based on a target bit rate, improve stability of the bit rate in a transmission process, and further improve anti-interference performance of the encoded bitstream for sending the audio signal.

In an implementation, the importance degree is indicated by a scale factor of a sub-band on which a frequency to which the spectrum value belongs is located, and the scale factor of the sub-band is obtained by decoding the encoded bitstream.

In an implementation, the determining, based on the importance degree, a code value and quantization indication information of a residual spectrum value in the encoded bitstream includes: determining, in all sub-bands of the audio signal, a reference sub-band having a largest scale factor; and determining a code value and quantization indication information of a residual spectrum value of a sub-band other than the reference sub-band in the encoded bitstream based on a distance from the sub-band other than the reference sub-band to the reference sub-band.

In an implementation, when a distance from a first sub-band to the reference sub-band is shorter than a distance from a second sub-band to the reference sub-band, a code value of a residual spectrum value of the first sub-band is before a code value of a residual spectrum value of the second sub-band, and quantization indication information of the residual spectrum value of the first sub-band is before quantization indication information of the residual spectrum value of the second sub-band.

In an implementation, locations of the code value and the quantization indication information of the residual spectrum value of each sub-band in the encoded bitstream are further obtained based on a condition in which the sub-band is masked by a psychoacoustic spectrum, a code value of a residual spectrum value of a sub-band masked by the psychoacoustic spectrum is before a code value of a residual spectrum value of a sub-band not masked by the psychoacoustic spectrum, quantization indication information of the residual spectrum value of the sub-band masked by the psychoacoustic spectrum is before quantization indication information of the residual spectrum value of the sub-band not masked by the psychoacoustic spectrum, and the condition in which the sub-band is masked by the psychoacoustic spectrum is obtained based on the encoded bitstream.

In an implementation, the performing a dequantization operation on the code value of the residual spectrum value based on the quantization indication information of the residual spectrum value, to obtain a dequantized code value includes: determining, based on the quantization indication information of the residual spectrum value, an offset value for performing the dequantization operation on the residual spectrum value; and performing the dequantization operation based on the code value of the residual spectrum value and the offset value, to obtain the dequantized code value.

According to a fourth aspect, the present disclosure provides a quantization apparatus. The quantization apparatus is used in an encoder side, and the quantization apparatus includes a first processing module, a second processing module, and a third processing module. The first processing module is configured to obtain a psychoacoustic spectrum envelope coefficient of each sub-band based on a scale factor of each sub-band and a target bit depth for encoding an audio signal. The second processing module is configured to determine, based on the psychoacoustic spectrum envelope coefficient of the sub-band, a target spectrum value that needs to be quantized in the sub-band, where a first total quantity of bits consumed by the target spectrum value in an encoded frame is less than or equal to a quantity of available bits of each frame of signal, and the quantity of available bits is determined based on a target bit rate that can be used by the encoder side to transmit the audio signal to a decoder side. The third processing module is configured to obtain a quantized value of the target spectrum value based on the target spectrum value.

Optionally, the second processing module is configured to: determine, based on the psychoacoustic spectrum envelope coefficient of the sub-band, a psychoacoustic spectrum for masking a spectrum of the audio signal; obtain, from a spectrum value of the audio signal, a to-be-determined spectrum value that is in the sub-band and that is not masked by the psychoacoustic spectrum; and determine, based on the to-be-determined spectrum value, the target spectrum value that needs to be quantized in the sub-band.

Optionally, the second processing module is configured to: obtain a second total quantity of bits consumed by the to-be-determined spectrum value in the encoded frame; when the second total quantity of bits is less than or equal to the quantity of available bits of each frame of signal, determine the to-be-determined spectrum value as the target spectrum value; and when the second total quantity of bits is greater than the quantity of available bits of each frame of signal, adjust the psychoacoustic spectrum envelope coefficient of the sub-band, and determine, based on an adjusted psychoacoustic spectrum envelope coefficient, a second total quantity of bits consumed by the to-be-determined spectrum value in the encoded frame, until the second total quantity of bits that is consumed by the to-be-determined spectrum value in the encoded frame and that is determined based on the adjusted psychoacoustic spectrum envelope coefficient is less than or equal to the quantity of available bits of each frame of signal; and determine the to-be-determined spectrum value as the target spectrum value. The adjusting the psychoacoustic spectrum envelope coefficient of the sub-band, and determining, based on an adjusted psychoacoustic spectrum envelope coefficient, a second total quantity of bits consumed by the to-be-determined spectrum value in the encoded frame includes: adjusting the psychoacoustic spectrum envelope coefficient of the sub-band in the audio signal in a first adjustment manner; updating the to-be-determined spectrum value based on the adjusted psychoacoustic spectrum envelope coefficient; and obtaining, based on an updated to-be-determined spectrum value, the second total quantity of bits consumed by the updated to-be-determined spectrum value in the encoded frame.

Optionally, the first adjustment manner is obtained based on the target bit depth.

Optionally, the first adjustment manner indicates to increase the psychoacoustic spectrum envelope coefficient of the sub-band in the audio signal when the second total quantity of bits is greater than the quantity of available bits of each frame of signal.

Optionally, the first adjustment manner indicates to adjust a psychoacoustic spectrum envelope coefficient of a second sub-band in the audio signal after adjustment of a psychoacoustic spectrum envelope coefficient of a first sub-band in the audio signal is completed, and a frequency of the first sub-band is higher than a frequency of the second sub-band.

Optionally, the second processing module is configured to: quantize the to-be-determined spectrum value based on the psychoacoustic spectrum envelope coefficient of the sub-band to obtain a quantized value of the to-be-determined spectrum value; and obtain a quantity of bits consumed by the encoder side to encode each quantized value of each frame of signal to obtain the second total quantity of bits.

Optionally, the second processing module is configured to: estimate, based on the psychoacoustic spectrum envelope coefficient of the sub-band, a third total quantity of bits consumed by the to-be-determined spectrum value in the encoded frame; when a difference between the third total quantity of bits and the quantity of available bits of each frame of signal falls within a first threshold range, determine to execute a process of obtaining the second total quantity of bits consumed by the to-be-determined spectrum value in the encoded frame; and when the difference between the third total quantity of bits and the quantity of available bits of each frame of signal is outside of the first threshold range, adjust the psychoacoustic spectrum envelope coefficient of the sub-band, and determine, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determine to execute the process of obtaining the second total quantity of bits consumed by the to-be-determined spectrum value in the encoded frame. The adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame includes: adjusting the psychoacoustic spectrum envelope coefficient of the sub-band in the audio signal in a second adjustment manner; updating the to-be-determined spectrum value based on the adjusted psychoacoustic spectrum envelope coefficient; and obtaining, based on an updated to-be-determined spectrum value, the third total quantity of bits consumed by the updated to-be-determined spectrum value in the encoded frame.

Optionally, the second processing module is configured to: estimate, based on the psychoacoustic spectrum envelope coefficient of the sub-band, a third total quantity of bits consumed by the to-be-determined spectrum value in the encoded frame; when a difference between the third total quantity of bits and the quantity of available bits of each frame of signal falls within a first threshold range, determine the to-be-determined spectrum value as the target spectrum value; and when the difference between the third total quantity of bits and the quantity of available bits of each frame of signal is outside of the first threshold range, adjust the psychoacoustic spectrum envelope coefficient of the sub-band, and determine, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determine the to-be-determined spectrum value as the target spectrum value. The adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame includes: adjusting the psychoacoustic spectrum envelope coefficient of the sub-band in the audio signal in a second adjustment manner; updating the to-be-determined spectrum value based on the adjusted psychoacoustic spectrum envelope coefficient; and obtaining, based on an updated to-be-determined spectrum value, the third total quantity of bits consumed by the updated to-be-determined spectrum value in the encoded frame.

Optionally, the second adjustment manner is obtained based on the target bit depth.

Optionally, the second adjustment manner indicates to increase the psychoacoustic spectrum envelope coefficient of the sub-band in the audio signal when the third total quantity of bits is greater than the quantity of available bits of each frame of signal, or decrease the psychoacoustic spectrum envelope coefficient of the sub-band in the audio signal when the third total quantity of bits is less than the quantity of available bits of each frame of signal.

Optionally, the second adjustment manner indicates to adjust a psychoacoustic spectrum envelope coefficient of a fourth sub-band in the audio signal after adjustment of a psychoacoustic spectrum envelope coefficient of a third sub-band in the audio signal is completed, and a frequency of the third sub-band is higher than a frequency of the fourth sub-band.

Optionally, the second processing module is configured to: obtain, based on the psychoacoustic spectrum envelope coefficient of the sub-band, an average quantity of bits consumed by each spectrum value in the sub-band; obtain, based on the average quantity of bits of the sub-band and a total quantity of spectrum values included in the sub-band, a fourth total quantity of bits consumed by the spectrum value in the sub-band; and obtain the third total quantity of bits based on the fourth total quantity of bits consumed by the sub-band.

According to a fifth aspect, the present disclosure provides a quantization apparatus. The quantization apparatus is used in an encoder side, and the quantization apparatus includes a first processing module, a second processing module, a third processing module, and a providing module. The first processing module is configured to: when a first total quantity of bits consumed by a target spectrum value in an encoded frame is less than a quantity of available bits of each frame of signal, determine, based on an importance degree of information represented by a spectrum value of an audio signal, a residual spectrum value that needs to be quantized in other spectrum values, where the other spectrum values are spectrum values other than the target spectrum value in spectrum values of the audio signal. The second processing module is configured to obtain a quantized value of the residual spectrum value based on the residual spectrum value. The third processing module is configured to obtain quantization indication information of the residual spectrum value based on the residual spectrum value, where the quantization indication information indicates a manner of dequantizing the residual spectrum value. The providing module is configured to provide the quantization indication information for a decoder side.

Optionally, the importance degree is indicated by a scale factor of a sub-band on which a frequency to which the spectrum value belongs is located.

Optionally, the first processing module is configured to: determine, in all sub-bands of the audio signal, a reference sub-band having a largest scale factor; determine, based on a distance from each sub-band other than the reference sub-band to the reference sub-band, weight of another spectrum value of the sub-band to be the residual spectrum value; and determine, in descending order of the weights, whether an another spectrum value of a corresponding sub-band is the residual spectrum value until a difference between a fifth total quantity of bits consumed by the target spectrum value and all the residual spectrum value in the encoded frame and the quantity of available bits of each frame of signal falls within a second threshold range, where when the another spectrum value of a sub-band is used as the residual spectrum value, if the fifth total quantity of bits consumed by the target spectrum value and all the determined residual spectrum values in the encoded frame is greater than the quantity of available bits of each frame of signal, neither the another spectrum value of the sub-band nor another spectrum value of another sub-band whose weight is less than or equal to a weight of the sub-band can be used as the residual spectrum value.

Optionally, a weight of any sub-band is inversely correlated with a distance from the any sub-band to the reference sub-band.

Optionally, a weight of a sub-band is further obtained based on a condition in which the sub-band is masked by a psychoacoustic spectrum, and a weight of a sub-band masked by the psychoacoustic spectrum is greater than a weight of a sub-band not masked by the psychoacoustic spectrum.

Optionally, the third processing module is configured to: perform rounding processing on the residual spectrum value; and determine, based on a residual spectrum value on which rounding processing is performed, a quantization manner for quantizing the residual spectrum value, to obtain the quantization indication information.

Optionally, the target spectrum value is determined according to the quantization method in any design in the first aspect.

According to a sixth aspect, the present disclosure provides a dequantization apparatus. The dequantization apparatus is used in a decoder side, and the dequantization apparatus includes a receiving module, an obtaining module, a determining module, and a processing module. The receiving module is configured to receive an encoded bitstream provided by an encoder side. The obtaining module is configured to obtain, based on the encoded bitstream, an importance degree of information represented by a spectrum value of an audio signal. The determining module is configured to determine, based on the importance degree, a code value and quantization indication information of a residual spectrum value in the encoded bitstream, where the quantization indication information indicates a manner of dequantizing the residual spectrum value by the encoder side. The processing module is configured to perform a dequantization operation on the code value of the residual spectrum value based on the quantization indication information of the residual spectrum value, to obtain a dequantized code value.

Optionally, the importance degree is indicated by a scale factor of a sub-band on which a frequency to which the spectrum value belongs is located, and the scale factor of the sub-band is obtained by decoding the encoded bitstream.

Optionally, the determining module is configured to: determine, in all sub-bands of the audio signal, a reference sub-band having a largest scale factor; and determine a code value and quantization indication information of a residual spectrum value of a sub-band other than the reference sub-band in the encoded bitstream based on a distance from the sub-band other than the reference sub-band to the reference sub-band.

Optionally, when a distance from a first sub-band to the reference sub-band is shorter than a distance from a second sub-band to the reference sub-band, a code value of a residual spectrum value of the first sub-band is before a code value of a residual spectrum value of the second sub-band, and quantization indication information of the residual spectrum value of the first sub-band is before quantization indication information of the residual spectrum value of the second sub-band.

Optionally, locations of the code value and the quantization indication information of the residual spectrum value of each sub-band in the encoded bitstream are further obtained based on a condition in which the sub-band is masked by a psychoacoustic spectrum, a code value of a residual spectrum value of a sub-band masked by the psychoacoustic spectrum is before a code value of a residual spectrum value of a sub-band not masked by the psychoacoustic spectrum, quantization indication information of the residual spectrum value of the sub-band masked by the psychoacoustic spectrum is before quantization indication information of the residual spectrum value of the sub-band not masked by the psychoacoustic spectrum, and the condition in which the sub-band is masked by the psychoacoustic spectrum is obtained based on the encoded bitstream.

Optionally, the processing module is configured to: determine, based on the quantization indication information of the residual spectrum value, an offset value for performing a dequantization operation on the residual spectrum value; and perform the dequantization operation based on the code value of the residual spectrum value and the offset value, to obtain the dequantized code value.

According to a seventh aspect, the present disclosure provides a computer device, including a memory and a processor. The memory stores program instructions, and the processor runs the program instructions to perform the method according to any one of the first aspect, the second aspect, and the third aspect.

According to an eighth aspect, the present disclosure provides a computer-readable storage medium. The storage medium stores a computer program, and when the computer program is executed by a processor, steps of the method in any one of the first aspect, the second aspect, and the third aspect are implemented.

According to a ninth aspect, the present disclosure provides a computer program product. The computer program product stores computer instructions, and when the computer instructions are executed by a processor, steps of the method in any one of the first aspect, the second aspect, and the third aspect are implemented.

### BRIEF DESCRIPTION OF DRAWINGS

FIG. 1 is a diagram of a Bluetooth interconnection scenario according to an embodiment of the present disclosure.

FIG. 2 is a diagram of a system framework related to both a quantization method and a dequantization method according to an embodiment of the present disclosure.

FIG. 3 is a diagram of an audio encoding and decoding overall framework according to an embodiment of the present disclosure.

FIG. 4 is a diagram of a structure of a computer device according to an embodiment of the present disclosure.

FIG. 5 is a flowchart of a quantization method according to an embodiment of the present disclosure.

FIG. 6 is a flowchart of determining, based on a psychoacoustic spectrum envelope coefficient of a sub-band, a target spectrum value that needs to be quantized in the sub-band according to an embodiment of the present disclosure.

FIG. 7 is a flowchart of a first adjustment process according to an embodiment of the present disclosure.

FIG. 8 is a flowchart of determining, based on a psychoacoustic spectrum envelope coefficient of a sub-band, a third total quantity of bits consumed by a to-be-determined spectrum value in an encoded frame according to an embodiment of the present disclosure.

FIG. 9 is a flowchart of a second adjustment process according to an embodiment of the present disclosure.

FIG. 10 is a flowchart of obtaining a second total quantity of bits consumed by a to-be-determined spectrum value in an encoded frame according to an embodiment of the present disclosure.

FIG. 11 is a flowchart of a quantization method according to an embodiment of the present disclosure.

FIG. 12 is a flowchart of determining, in another spectrum value based on an importance degree of information represented by a spectrum value of an audio signal, a residual spectrum value that needs to be quantized according to an embodiment of the present disclosure.

FIG. 13 is a flowchart of a dequantization method according to an embodiment of the present disclosure.

FIG. 14 is a diagram of a structure of a quantization apparatus according to an embodiment of the present disclosure.

FIG. 15 is a diagram of a structure of a quantization apparatus according to an embodiment of the present disclosure.

FIG. 16 is a diagram of a structure of a dequantization apparatus according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

First, an implementation environment and background knowledge related to embodiments of the present disclosure are described.

As short-range transmission devices (such as Bluetooth devices) like true wireless stereo (TWS) headsets, smart speakers, and smart watches in people's daily life are widely popularized and used, people's requirements for high-quality audio playing experience in various scenarios become increasingly urgent, especially in environments where Bluetooth signals are vulnerable to interference, such as subways, airports, and railway stations. In a short-range transmission scenario, due to a limit of a channel connecting an audio sending device and an audio receiving device on a data transmission size, during audio signal transmission, to reduce a bandwidth occupied during audio signal transmission, an audio encoder in the audio sending device is generally used to encode the audio signal, and then an encoded audio signal is transmitted to the audio receiving device. After receiving the encoded audio signal, the audio receiving device needs to decode the encoded audio signal by using an audio decoder in the audio receiving device, and then plays a decoded audio signal. It can be learned that, while the short-range transmission devices are popularized, various audio codecs are also promoted to flourish. The short-range transmission scenario may include a Bluetooth transmission scenario, a wireless transmission scenario, or the like. In embodiments of the present disclosure, a Bluetooth transmission scenario is used as an example to describe a quantization method provided in embodiments of the present disclosure.

Currently, the Bluetooth audio codecs include a sub-band encoder (sub-band coding, SBC), a Bluetooth advanced audio encoder (advanced audio coding, AAC) series (such as AAC-LC, AAC-LD, AAC-HE and AAC-HEv2) of the moving picture experts group (MPEG), an LDAC, an aptX series (such as aptX, aptX HD, and aptX low-latency) encoder, a low-latency high-definition audio codec (LHDC), a low-power-consumption low-latency LC3 audio codec, an LC3plus, and the like.

In a transmission process of the audio signal, a throughput and stability of a connection between an audio sending device and an audio receiving device greatly affect quality of the audio signal. For example, data shows that all codecs are affected when a received signal strength indication of Bluetooth connection quality is below −80 dBm. However, for a Bluetooth codec, when Bluetooth connection quality is severely interfered, if bit rates fluctuate greatly, a duty cycle of the signal sent by the audio sending device to the audio receiving device is high. As a result, a packet loss and discontinuity are likely to occur, causing severe deterioration of subjective listening experience of human ears. Therefore, ensuring stability of the bit rate in the transmission process is a technical problem that needs to be urgently resolved in a Bluetooth short-range scenario, or the like.

In view of this, embodiments of the present disclosure provide the quantization method. The quantization method may be considered as a bit allocation method in a quantization process. The method includes: obtaining a psychoacoustic spectrum envelope coefficient of each sub-band based on a scale factor of each sub-band and a target bit depth for encoding an audio signal; determining, based on the psychoacoustic spectrum envelope coefficient of the sub-band, a target spectrum value that needs to be quantized in the sub-band; and obtaining a quantized value of the target spectrum value based on the target spectrum value, where a first total quantity of bits consumed by the target spectrum value in an encoded frame is less than or equal to a quantity of available bits of each frame of signal, and the quantity of available bits is determined based on a target bit rate that can be used by an encoder side to transmit the audio signal to a decoder side; and the audio signal may be a signal presented in an audio form, such as a voice signal or a music signal.

The quantization method actually indicates a process of performing bit allocation based on the target bit rate, to control quantization precision based on the target bit rate. In addition, the process is implemented by adjusting the psychoacoustic spectrum envelope coefficient of the sub-band, and performing masking guide on a spectrum value in the sub-band based on the psychoacoustic spectrum envelope coefficient. Therefore, quantization is performed according to the quantization method, to help maintain a bit rate of each frame in a constant state based on the target bit rate, improve stability of the bit rate in a transmission process, and further improve anti-interference performance of an encoded bitstream for sending the audio signal.

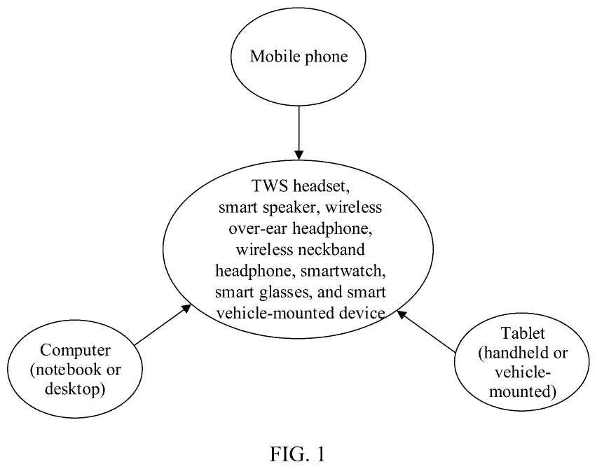

FIG. 1 is a diagram of an application scenario related to a quantization method and a dequantization method according to an embodiment of the present disclosure. Refer to FIG. 1. The application scenario includes an audio sending device and an audio receiving device. An audio encoder is configured for the audio sending device. An audio decoder is configured for the audio receiving device. Optionally, the audio sending device may be devices, such as a mobile phone, a computer (for example, a notebook computer or a desktop computer), a tablet (for example, a handheld tablet or a vehicle-mounted tablet), an intelligent wearable device, or the like, that can send an audio data stream. The audio receiving device may be devices, such as a headset (for example, a TWS headset, a wireless over-ear headphone, or a wireless neckband headphone), a speaker (for example, a smart speaker), an intelligent wearable device (for example, a smartwatch or smart glasses), a smart vehicle-mounted device, or the like, that can receive and play the audio data stream. In some scenarios, the audio receiving device in a short-range transmission scenario may also be a mobile phone, a computer, a tablet, or the like.

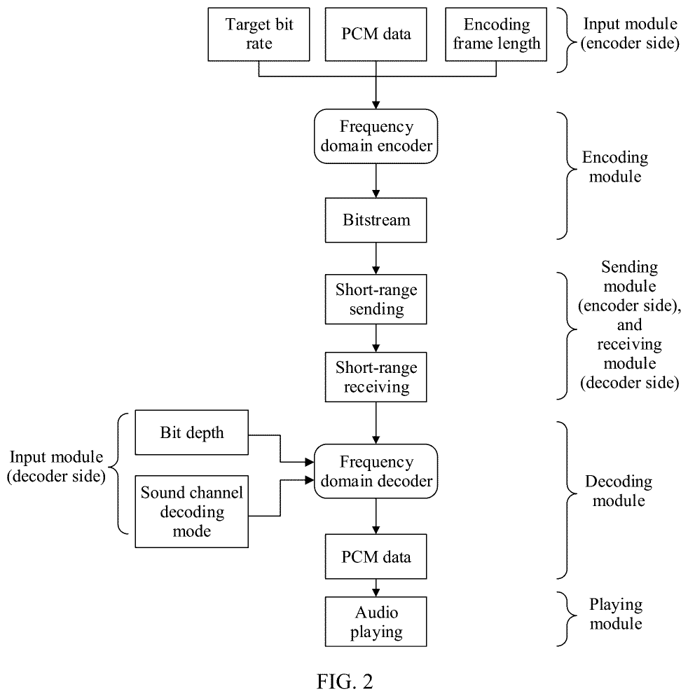

FIG. 2 is a diagram of a system framework related to both a quantization method and a dequantization method according to an embodiment of the present disclosure. Refer to FIG. 2. The system includes an encoder side and a decoder side. The encoder side includes an input module, an encoding module, and a sending module. The decoder side includes a receiving module, an input module, a decoding module, and a playing module.

At the encoder side, a user determines one encoding mode from two encoding modes based on a usage scenario, where the two encoding modes are a low-latency encoding mode and a high-sound-quality encoding mode. Encoding frame lengths of the two encoding modes are 5 ms and 10 ms respectively. For example, if the usage scenario is playing a game, live broadcasting, or making a call, the user may select the low-latency encoding mode; or if the usage scenario is enjoying music, or the like through a headset or a speaker, the user may select the high-sound-quality encoding mode. The user further needs to provide a to-be-encoded audio signal (pulse code modulation (PCM) data shown in FIG. 2) to the encoder side. In addition, the user further needs to set a target bit rate of a bitstream obtained through encoding, namely, an encoding bit rate of the audio signal. A higher target bit rate indicates better sound quality, but poorer anti-interference performance of a bitstream in a short-range transmission process. A lower target bit rate indicates poorer sound quality, but higher anti-interference performance of a bitstream in a short-range transmission process. Simply speaking, the input module at the encoder side obtains the encoding frame length, the encoding bit rate, and the to-be-encoded audio signal that are submitted by the user.

The input module at the encoder side inputs data submitted by the user into a frequency domain encoder of the encoding module.

The frequency domain encoder of the encoding module performs encoding based on the received data to obtain a bitstream. A frequency domain encoder side analyzes the to-be-encoded audio signal to obtain signal characteristics (including a mono/dual channel signal, a stable/non-stable signal, a full-bandwidth/narrow-bandwidth signal, a subjective/objective signal, and the like). The signal enters a corresponding encoding processing submodule based on the signal characteristics and a bit rate level (namely, the encoding bit rate). The encoding processing submodule encodes the audio signal, packages a packet header (including a sampling rate, a quantity of channels, an encoding mode, and a frame length) of the bitstream, and finally obtains the bitstream.

The sending module at the encoder side sends the bitstream to the decoder side. Optionally, the sending module is the sending module shown in FIG. 2 or another type of sending module. This is not limited in embodiments of the present disclosure.

At the decoder side, after receiving the bitstream, the receiving module at the decoder side sends the bitstream to a frequency domain decoder of the decoding module, and notifies the input module at the decoder side to obtain a configured bit depth, a configured sound channel decoding mode, and the like. Optionally, the receiving module is the receiving module shown in FIG. 2 or another type of receiving module. This is not limited in embodiments of the present disclosure.

The input module at the decoder side inputs obtained information such as the bit depth and the sound channel decoding mode into the frequency domain decoder of the decoding module.

The frequency domain decoder of the decoding module decodes the bitstream based on the bit depth, the sound channel decoding mode, and the like, to obtain required audio data (PCM data shown in FIG. 2), and sends the obtained audio data to the playing module. The playing module plays audio. The sound channel decoding mode indicates a channel that needs to be decoded.

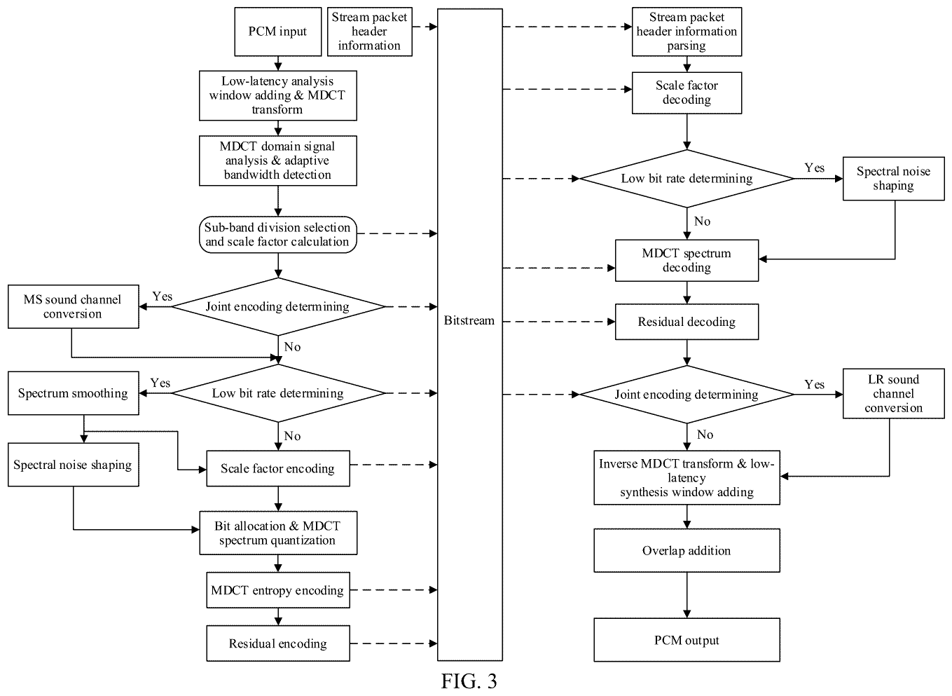

FIG. 3 is a diagram of an audio encoding and decoding overall framework according to an embodiment of the present disclosure. Refer to FIG. 3. An encoding procedure at an encoder side includes the following steps.

### (1) PCM Input Module

A PCM input module inputs PCM data. The PCM data is mono-channel data or dual-channel data. A bit depth can be 16-bit (bit), 24-bit, 32-bit floating point, or 32-bit fixed point. Optionally, the PCM input module converts the input PCM data to a same bit depth, for example, a 24-bit depth, performs de-interleaving on the PCM data, and then places the PCM data based on a left channel and a right channel.

### (2) Low-Latency Analysis Window Adding & Modified Discrete Cosine Transform (MDCT) Module

A low-latency analysis window is added to the PCM data processed in step (1), and MDCT transform is performed to obtain spectrum data of an MDCT domain. The window is added to prevent spectrum leakage.

### (3) MDCT Domain Signal Analysis Module & Adaptive Bandwidth Detection Module

An MDCT domain signal analysis module takes effect in a full bit rate scenario, and an adaptive bandwidth detection module is activated at a low bit rate (for example, a bit rate≤150 kbps/sound channel). First, bandwidth detection is performed on the spectrum data of the MDCT domain obtained in step (2), so as to obtain a cut-off frequency or an effective bandwidth. Then, signal analysis is performed on spectrum data within the effective bandwidth, that is, whether frequency distribution is centralized or even is analyzed to obtain an energy concentration degree, and a flag indicating whether an audio signal to be encoded is an objective signal or a subjective signal (the flag of the objective signal is 1, and the flag of the subjective signal is 0) is obtained based on the energy concentration degree. If the signal is the objective signal, spectral noise shaping (SNS) processing and MDCT spectrum smoothing are not performed on a scale factor at a low bit rate, because this reduces encoding effect of the objective signal. Then, whether to perform a sub-band cut-off operation in the MDCT domain is determined based on a bandwidth detection result, the flag of the subjective signal, and the flag of the objective signal. If the audio signal is the objective signal, the sub-band cut-off operation is not performed; or if the audio signal is the subjective signal and the bandwidth detection result is identified as 0 (in a full bandwidth), the sub-band cut-off operation is determined by a bit rate; or if the audio signal is the subjective signal and the bandwidth detection result is not identified as 0 (that is, a bandwidth is less than half of a limited bandwidth of a sampling rate), the sub-band cut-off operation is determined by the bandwidth detection result.

### (4) Sub-Band Division Selection and Scale Factor Calculation Module

Based on a bit rate level, and the flag of the subjective signal and the flag of objective signal and the cut-off frequency that are obtained in step (3), an optimal sub-band division manner is selected from a plurality of sub-band division manners, and a total quantity of sub-bands for encoding the audio signal is obtained. In addition, an envelope of a spectrum is obtained through calculation, that is, a scale factor corresponding to the selected sub-band division manner is calculated.

### (5) MS Sound Channel Conversion Module

For the dual-channel PCM data, joint encoding determining is performed based on the scale factor calculated in step (4), that is, whether to perform MS sound channel conversion for the left and right channel data is determined.

### (6) Spectrum Smoothing Module and Scale Factor-Based Spectral Noise Shaping Module

A spectrum smoothing module performs MDCT spectrum smoothing based on a setting of the low bit rate (for example, the bit rate≤150 kbps/sound channel), and a spectral noise shaping module performs, based on the scale factor, spectral noise shaping on data on which spectrum smoothing is performed, to obtain an adjustment factor, where the adjustment factor is used to quantize a spectrum value of the audio signal. The setting of the low bit rate is controlled by a low bit rate determining module. When the setting of the low bit rate is not met, spectrum smoothing and spectral noise shaping do not need to be performed.

### (7) Scale Factor Encoding Module

A scale factor encoding module performs differential encoding or entropy encoding on scale factors of a plurality of sub-bands based on distribution of the scale factors.

### (8) Bit Allocation & MDCT Spectrum Quantization and Entropy Encoding Module

Based on the scale factor obtained in step (4) and the adjustment factor obtained in step (6), encoding is controlled to be in a constant bit rate (CBR) encoding mode according to a bit allocation strategy of rough estimation and precise estimation, and an MDCT spectrum value is quantized and entropy encoded.

### (9) Residual Encoding Module

If bit consumption in step (8) does not reach a target bit, importance sorting is further performed on the sub-bands, and a bit is preferably allocated to encoding of an MDCT spectrum value of an important sub-band.

### (10) Stream Packet Header Information Packaging Module

Packet header information includes the audio sampling rate (for example, 44.1 kHz/48 kHz/88.2 kHz/96 kHz), channel information (for example, mono and dual channels), the encoding frame length (for example, 5 ms and 10 ms), and the encoding mode (for example, time domain, frequency domain, time-domain to frequency-domain or frequency-domain to time-domain mode).

### (11) Bit Stream (Namely, Bitstream) Sending Module

The bitstream includes the packet header, side information, payload, and the like. The packet header carries the packet header information, and the packet header information is as described in step (10). The side information includes information, such as the encoded bitstream of the scale factor, information about the selected sub-band division manner, cut-off frequency information, a low bit rate flag, joint encoding determining information (namely, an MS conversion flag), and a quantization step length. The payload includes the encoded bitstream and a residual encoded bitstream of the MDCT spectrum.

A decoding procedure at a decoder side includes the following steps.

### (1) Stream Packet Header Information Parsing Module

A stream packet header information parsing module parses the packet header information from the received bitstream, where the packet header information includes information such as the sampling rate, the channel information, the encoding frame length, and the encoding mode of the audio signal, and obtains the encoding bit rate through calculation based on a bitstream size, the sampling rate, and the encoding frame length, that is, obtains bit rate level information.

### (2) Scale Factor Decoding Module

A scale factor decoding module decodes the side information from the bitstream, where the side information includes information, such as the information about the selected sub-band division manner, the cut-off frequency information, the low bit rate flag, the joint encoding determining information, and the quantization step length, and the scale factors of the sub-bands.

### (3) Scale Factor-Based Spectral Noise Shaping Module

At the low bit rate (for example, the encoding bit rate less than 150 kbps/sound channel), spectral noise shaping further needs to be performed based on the scale factor to obtain the adjustment factor, where the adjustment factor is used to dequantize a code value of the spectrum value. The setting of the low bit rate is controlled by the low bit rate determining module. When the setting of the low bit rate is not met, spectral noise shaping does not need to be performed.

### (4) MDCT Spectrum Decoding Module and Residual Decoding Module

An MDCT spectrum decoding module decodes the MDCT spectrum data in the decoded bitstream based on the information about the sub-band division manner, the quantization step information, and the scale factors obtained in step (2). Hole padding is performed at a low bit rate level, and if a bit obtained through calculation is still remaining, a residual decoding module performs residual decoding, to obtain MDCT spectrum data of another sub-band, so as to obtain final MDCT spectrum data.

### (5) LR Sound Channel Conversion Module

Based on the side information obtained in step (2), if it is determined, through joint encoding determining, that a dual-channel joint encoding mode rather than a decoding low-power mode (for example, the encoding bit rate is greater than 150 kbps/sound channel and the sampling rate is greater than 88.2 kHz) is used, LR sound channel conversion is performed on the MDCT spectrum data obtained in step (4).

### (6) Inverse MDCT Transform Module & Low-Latency Synthesis Window Module Adding and an Overlap Addition Module

On the basis of step (4) and step (5), an inverse MDCT transform module performs MDCT inverse transform on the obtained MDCT spectrum data to obtain a time-domain aliased signal. Then a low-latency synthesis window module adds a low-latency synthesis window to the time-domain aliased signal. An overlap addition module superimposes time-domain aliased buffer signals of a current frame and a previous frame to obtain a PCM signal, that is, obtains the final PCM data through overlap addition.

### (7) PCM Output Module

A PCM output module outputs PCM data of a corresponding sound channel based on a configured bit depth and sound channel decoding mode.

It should be noted that the audio encoding and decoding framework shown in FIG. 3 is merely used as an example of the terminal in embodiments of the present disclosure, and is not intended to limit embodiments of the present disclosure. A person skilled in the art may obtain another encoding and decoding framework on the basis of FIG. 3.

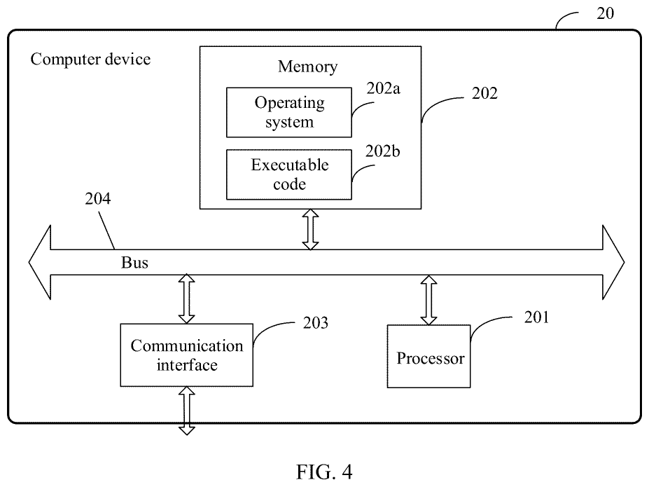

FIG. 4 is a diagram of a structure of a computer device according to an embodiment of the present disclosure. Optionally, the computer device may be any device shown in FIG. 1. For example, the computer device may be an audio sending device. In this case, the computer device can implement some or all functions of the quantization method provided in embodiments of the present disclosure. As shown in FIG. 4, the computer device 20 includes a processor 201, a memory 202, a communication interface 203, and a bus 204. The processor 201, the memory 202, and the communication interface 203 implement communication connections with each other through the bus 204.

The computer device 20 may include a plurality of processors, for example, the processor 201 shown in FIG. 4 and a processor 205. Each of these processors is a single-core processor or a multi-core processor. Optionally, the processor herein is one or more devices, circuits, and/or processing cores for processing data (for example, computer program instructions). The processor 201 may include a general-purpose processor and/or a dedicated hardware chip. The general-purpose processor may include a central processing unit (CPU), a microprocessor, or a graphics processing unit (GPU). For example, the CPU is a single-core processor (single-CPU), or a multi-core processor (multi-CPU). The dedicated hardware chip is a hardware module capable of performing high-performance processing. The dedicated hardware chip includes at least one of a digital signal processor, an application-specific integrated circuit (ASIC), a field-programmable logic gate array (FPGA), and a network processor (NP). Alternatively, the processor 201 may be an integrated circuit chip, and has a signal processing capability. In an implementation process, some or all functions of the quantization method and the dequantization method in the present disclosure may be completed by using an integrated logic circuit of hardware in the processor 201 or instructions in a form of software.

The memory 202 is configured to store a computer program, and the computer program includes an operating system 202a and executable code (namely, program instructions) 202b. The memory 202 is, for example, a read-only memory (ROM), or another type of static storage device that can store static information and instructions, for another example, a random access memory (RAM), or another type of dynamic storage device that can store information and instructions, for another example, an electrically erasable programmable read-only memory (EEPROM), a compact disc read-only memory (CD-ROM), other optical disk storage, optical disc storage (including a compact disc, a laser disc, an optical disc, a digital versatile disc, a Blu-ray disc, or the like), a magnetic disk storage medium, another magnetic storage device, or any other medium that can be used to carry or store expected executable code in forms of instructions or in a form of a data structure and that can be accessed by a computer. However, this is not limited. For example, the memory 202 is configured to store an egress port queue, and the like. For example, the memory 202 exists independently, and is connected to the processor 201 through the bus 204. Alternatively, the memory 202 and the processor 201 are integrated together. The memory 202 may store the executable code. When the executable code stored in the memory 202 is executed by the processor 201, the processor 201 is configured to perform the some or all functions of the quantization method and the dequantization method provided in embodiments of the present disclosure. In addition, for an implementation in which the processor 201 performs a corresponding function, refer to related descriptions in method embodiments. The memory 202 may further include a software module, data, and the like that are required by another running process like the operating system.

The communication interface 203 uses a transceiver module, for example, but not limited to a transceiver, to implement communication with another device or a communication network. The communication interface 203 includes a wired communication interface, or may optionally include a wireless communication interface. The wired communication interface is, for example, an Ethernet interface. Optionally, the Ethernet interface is an optical interface, an electrical interface, or a combination thereof. The wireless communication interface is a wireless local area network (WLAN) interface, a cellular network communication interface, a combination thereof, or the like.

The bus 204 is any type of communication bus configured to implement interconnection between internal components (for example, the memory 202, the processor 201, and the communication interface 203) in the computer device, for example, a system bus. In embodiments of the present disclosure, an example in which the foregoing components in the computer device are interconnected through the bus 204 is used for description. Optionally, the foregoing components in the computer device 20 may be in communication connection to each other in a connection manner other than the bus 204. For example, the foregoing components in the computer device 20 are interconnected through an internal logical interface.

Optionally, the computer device further includes an output device and an input device. The output device communicates with the processor 201, and can display information in a plurality of manners. For example, the output device is a liquid crystal display (LCD), a light emitting diode (LED) display device, a cathode ray tube (CRT) display device, a projector, or the like. The input device communicates with the processor 201, and can receive user's input in a plurality of manners. For example, the input device is a mouse, a keyboard, a touchscreen device, or a sensing device.

It should be noted that the foregoing plurality of components may be separately disposed on chips independent of each other, or at least some or all of the components may be disposed on a same chip. Whether the components are separately disposed on different chips or integrated and disposed on one or more chips usually depends on a requirement of a product design. Embodiments of the present disclosure impose no limitation on specific implementations of the foregoing components. Descriptions of procedures corresponding to the foregoing accompanying drawings have respective focuses. For a part that is not described in detail in a procedure, refer to related descriptions of other procedures.

All or some of the foregoing embodiments may be implemented by using software, hardware, firmware, or any combination thereof. When software is used to implement embodiments, all or some of embodiments may be implemented in a form of a computer program product. The computer program product that provides a program development platform includes one or more computer instructions. When these computer program instructions are loaded and executed on the computer device, all or some of the procedures or functions of the quantization method and the dequantization method provided in embodiments of the present disclosure are implemented.

The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium stores the computer program instructions that provide the program development platform.

In a possible implementation, the quantization method and the dequantization method provided in embodiments of the present disclosure may be implemented by using one or more function modules deployed on the computer device. The one or more function modules may be specifically implemented by executing an executable program by the computer device. When the quantization method and the dequantization method provided in embodiments of the present disclosure are implemented by using a plurality of function modules deployed on the computer device, the plurality of function modules may be deployed in a centralized manner or in a distributed manner. In addition, the plurality of function modules may be specifically implemented by executing a computer program by one or more computer devices. Each of the one or more computer devices can implement the some or all functions of the quantization method and the dequantization method provided in embodiments of the present disclosure.

It should be understood that the foregoing content is an example description of application scenarios of the quantization method and the dequantization method provided in embodiments of the present disclosure, and does not constitute a limitation on the application scenarios of the quantization method and the dequantization method. For example, in embodiments of the present disclosure, when implementation processes of the quantization method and the dequantization method are described, an example in which the quantization method and the dequantization method are applied to short-range transmission in a Bluetooth transmission scenario is used. However, it is not excluded that the quantization method and the dequantization method may be applied to another short-range transmission scenario. For example, the quantization method and the dequantization method may be applied to a short-distance transmission scenario of wireless transmission and another scenario. The quantization method and the dequantization method provided in embodiments of the present disclosure may be applied to an audio sending device in the short-range transmission scenario, namely, an encoder side in the short-range transmission scenario, or may be applied to an encoder side in another transmission scenario, or may be applied to an audio receiving device in the short-range transmission scenario, namely, a decoder side in the short-range transmission scenario, or may be applied to a decoder side in another transmission scenario. In other words, the quantization method and the dequantization method provided in embodiments of the present disclosure are applied to all scenarios related to an encoded audio signal. In addition, a person of ordinary skill in the art may learn that, as a service requirement changes, an application scenario may be adjusted based on an application requirement. The application scenarios are not listed one by one in embodiments of the present disclosure.

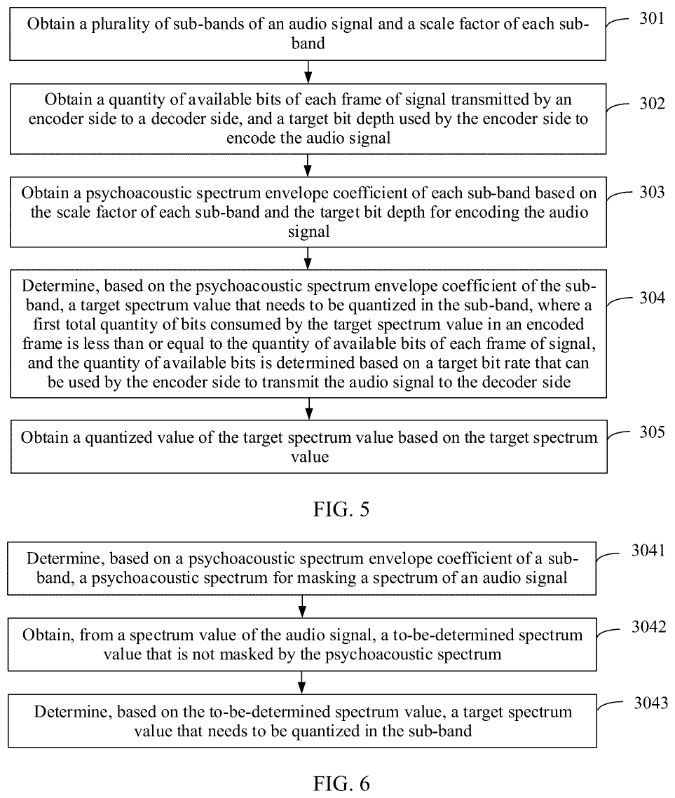

FIG. 5 is a flowchart of a quantization method according to an embodiment of the present disclosure. The method is applied to the audio sending device shown in FIG. 1. As shown in FIG. 5, the method includes the following steps.

Step 301: Obtain a plurality of sub-bands of an audio signal and a scale factor of each sub-band.

After obtaining the audio signal to be sent to an audio receiving device, the audio sending device may first add a low-latency analysis window to the audio signal, transform an audio signal added with the low-latency analysis window to frequency domain to obtain a frequency domain signal of the audio signal, and then divide the frequency domain signal to obtain the plurality of sub-bands (for example, 32 sub-bands) and obtain a scale factor (SF) of each sub-band. A scale factor of a sub-band indicates a maximum amplitude value of a sub-band frequency. For example, the scale factor of the sub-band may be a quantity of bits representing the maximum amplitude value.

Step 302: Obtain a quantity of available bits of each frame of signal transmitted by an encoder side to a decoder side, and a target bit depth used by the encoder side to encode the audio signal.

The quantity of available bits may be determined based on a target bit rate and a frame length. The target bit rate is a bit rate that can be used by the encoder side to transmit the audio signal to the decoder side. A bit rate indicates a quantity of data bits transmitted per unit of time during data transmission. The audio signal includes a plurality of signal frames. The frame length is a length of a signal frame. The frame length is usually represented by duration. In an implementation, a total quantity of bits that can be used for transmitting frames of signals may be determined based on the frame length and the target bit rate, and then a quantity of bits consumed by a packet header and side information (sideinfo) of a data packet for sending an encoded signal is subtracted from the total quantity of bits to obtain the quantity of available bits for transmitting each frame of signal. In addition, the total quantity of bits may be equal to a product of the frame length and the target bit rate.

The target bit depth used by the encoder side to encode the audio signal indicates a quantity of bits used for an amplitude at a time point when the encoder side encodes the audio signal. A larger quantity of bits used for an amplitude at a time point indicates a more accurate amplitude change. It should be noted that the audio signal also has a bit depth. When the bit depth of the audio signal is different from the target bit depth used by the encoder side to encode the audio signal, before the audio signal is quantized, bit depth conversion needs to be performed on the audio signal first to convert the bit depth of the audio signal into the target bit depth. For example, when the target bit depth is 24 bits, and the bit depth of the audio signal is 16 bits or 32 bits (for example, a 32-bit fixed point or 32-bit floating point), bit depth conversion needs to be performed on the audio signal first to convert the bit depth of the audio signal into 24 bits. Similarly, when the bit depth of the audio signal is different from the target bit depth used by the encoder side to encode the audio signal, after decoding an encoded bitstream, an audio decoder also needs to perform bit depth conversion on the audio signal obtained by decoding, to convert the bit depth of the audio signal obtained by decoding from the target bit depth to the bit depth of the audio signal. The target bit depth is an attribute value of both the encoder side and the decoder side, and does not change after an encoding system of the encoder side and a decoding system of the decoder side are determined.

Step 303: Obtain a psychoacoustic spectrum envelope coefficient of each sub-band based on the scale factor of each sub-band and the target bit depth for encoding the audio signal.

Generally, if all spectrum values are quantized and encoded, a quantity of bits consumed for encoding bitstreams of the spectrum values is far greater than a quantity of available bits determined based on the target bit rate. Therefore, in a quantization process, bit allocation needs to be first performed on the quantity of available bits, and then a quantization operation is performed on a spectrum value to which a bit is allocated. Bit allocation on the available bits refers to a process of determining specific spectrum values of the audio signal that need to be quantized and encoded, and specific spectrum values that do not need to be quantized and encoded. A spectrum value that does not need to be quantized and encoded may be processed as a masked state, and specific spectrum values that need to be masked may be measured based on a psychoacoustic spectrum. Therefore, a bit allocation process may be considered as a process of determining the psychoacoustic spectrum under limits of the target bit rate and the bit depth, and then determining, based on the psychoacoustic spectrum, the spectrum value that needs to be masked. The psychoacoustic spectrum may be represented by using psychoacoustic spectrum envelope coefficients (psychoacoustics scale factors) of the plurality of sub-bands of the audio signal. Correspondingly, the bit allocation process may be considered as a process of determining the psychoacoustic spectrum envelope coefficient of each sub-band of the audio signal under the limits of the target bit rate and the bit depth. This process is actually a process of determining an initial value of the psychoacoustic spectrum envelope coefficient of the sub-band based on the target bit rate, the bit depth, and an adjustment factor of the sub-band, determining, based on the initial value, the total quantity of bits consumed by the spectrum values that need to be quantized and encoded, determining, based on a value relationship between the total quantity of bits and the quantity of available bits, whether to dynamically adjust the initial value, and dynamically adjusting the psychoacoustic spectrum envelope coefficient when it is determined that the initial value needs to be dynamically adjusted.

In an implementation, a psychoacoustic spectrum envelope coefficient of an i^{th} sub-band may be obtained based on a scale factor and a dynamic adjustment factor of the i^{th} sub-band. The dynamic adjustment factor is an adjustable parameter for the psychoacoustic spectrum envelope coefficient. When the psychoacoustic spectrum envelope coefficient is adjusted, whether to adjust the dynamic adjustment factor may be determined based on the target bit rate. For example, because the psychoacoustic spectrum is used to determine the specific spectrum values that need to be masked, the psychoacoustic spectrum envelope coefficient of the i^{th} sub-band may be determined based on a smaller value of the scale factor and the dynamic adjustment factor of the i^{th} sub-band.

Optionally, a value range of the dynamic adjustment factor may be determined based on the bit depth. Because the bitstream is represented by using binary data, the value range may be determined based on a quantity of binary bits for representing the target bit depth. For example, when the target bit depth is 24 bits, because 2⁴=16<24<32=2⁵, it may be determined that there may be 32 dynamic adjustment factor values. In addition, because the target bit depth is 24 bits, it may be set that a non-negative number part of the value range of the dynamic adjustment factor includes 24 values, the non-negative number part represents an integer of a spectrum value, a negative number part includes 8 values, the negative number part represents a decimal of the spectrum value, and the value range may be integers in [−8, 23].

If noise shaping is performed on the scale factor, an adjustment factor (which may be referred to as a static adjustment factor) determined by noise shaping and the dynamic adjustment factor may be combined to adjust the psychoacoustic spectrum envelope coefficient. Optionally, a sum of the dynamic adjustment factor and the static adjustment factor may be determined as a total adjustment factor, and the psychoacoustic spectrum envelope coefficient of the i^{th} sub-band is determined based on a smaller value of the total adjustment factor and the scale factor of the i^{th} sub-band.

In addition, to balance sound quality of the audio signal obtained by decoding and compression efficiency of encoding, a maximum value and a minimum value of the psychoacoustic spectrum envelope coefficient may be set, so as to limit a value of the psychoacoustic spectrum envelope coefficient by using the maximum value and the minimum value. Limiting the value of the psychoacoustic spectrum envelope coefficient by using the maximum value can ensure the sound quality of the audio signal obtained by decoding. Limiting the value of the psychoacoustic spectrum envelope coefficient by using the minimum value can ensure the compression efficiency of encoding the audio signal. In an implementation, the maximum value and the minimum value may be determined based on the value range of the dynamic adjustment factor. For example, a maximum value of the dynamic adjustment factor may be determined as the maximum value of the psychoacoustic spectrum envelope coefficient, and a minimum value of the dynamic adjustment factor may be determined as the minimum value of the psychoacoustic spectrum envelope coefficient. For example, it is assumed that the range of the dynamic adjustment factor is [−8, 23], the maximum value of the psychoacoustic spectrum envelope coefficient is 23, and the minimum value of the psychoacoustic spectrum envelope coefficient is −8.

In this case, the psychoacoustic spectrum envelope coefficient may be determined based on the minimum value of the psychoacoustic spectrum envelope coefficient. Optionally, after the smaller value of the total adjustment factor and the scale factor of the i^{th} sub-band is obtained, the psychoacoustic spectrum envelope coefficient of the i^{th} sub-band may be determined based on a larger one of the smaller value and the minimum value. For example, the smaller value of the scale factor and the dynamic adjustment factor of the i^{th} sub-band may be determined, and the psychoacoustic spectrum envelope coefficient of the i^{th} sub-band is determined based on a larger one of the smaller value and the minimum value.

For example, the static adjustment factor dr_{adjust}(i), the dynamic adjustment factor dr, the scale factor E(i), the psychoacoustic spectrum envelope coefficient psySF(i), and the minimum value SF_BIT_MIN of the psychoacoustic spectrum envelope coefficient of the i^{th} sub-band may satisfy Formula 1:

psySF(i)=MAX(MIN(E(i),dr+dr_{adjust}(i)),SF_BIT_MIN),i∈[0,B−1]

MAX(x, y) indicates that a larger value between x and y is used. MIN(x, y) indicates that a smaller value between x and y is used. B is a total quantity of sub-bands of the audio signal. Optionally, the B sub-bands may be specifically sub-bands that need to be encoded in sub-bands of the audio signal, for example, sub-bands that need to be encoded and that are obtained based on a cut-off frequency of the audio signal.

Step 304: Determine, based on the psychoacoustic spectrum envelope coefficient of the sub-band, a target spectrum value that needs to be quantized in the sub-band, where a first total quantity of bits consumed by the target spectrum value in an encoded frame is less than or equal to the quantity of available bits of each frame of signal, and the quantity of available bits is determined based on the target bit rate that can be used by the encoder side to transmit the audio signal to the decoder side.

The audio signal includes a plurality of frames of signals, and encoding may be performed on the audio signal in a unit of a frame. In this case, a spectrum value in the encoded frame is a spectrum value of the audio signal included in the encoded frame.

The value of the psychoacoustic spectrum envelope coefficient of the sub-band determined in step 303 is the initial value of the psychoacoustic spectrum envelope coefficient. In a process of determining, based on the psychoacoustic spectrum envelope coefficient of the sub-band, the target spectrum value that needs to be quantized in the sub-band, the total quantity of bits consumed by the spectrum value that needs to be quantized and encoded needs to be determined based on the initial value, whether to dynamically adjust the initial value is determined based on a value relationship between the total quantity of bits and the quantity of available bits, and the psychoacoustic spectrum envelope coefficient is dynamically adjusted when it is determined that the initial value needs to be dynamically adjusted. In an implementation, as shown in FIG. 6, an implementation process of step 304 includes the following steps.

Step 3041: Determine, based on the psychoacoustic spectrum envelope coefficient of the sub-band, a psychoacoustic spectrum for masking a spectrum of the audio signal.

In a possible implementation, after the psychoacoustic spectrum envelope coefficients of the plurality of sub-bands are sequentially connected based on frequencies of the sub-bands, an obtained curve is the psychoacoustic spectrum.

Step 3042: Obtain, from the spectrum value of the audio signal, a to-be-determined spectrum value that is not masked by the psychoacoustic spectrum.

The spectra of the audio signal may also be represented by using a curve. An overall amplitude of the spectra of the audio signal is greater than an amplitude of the psychoacoustic spectrum. Therefore, a spectrum value between the spectra of the audio signal and the psychoacoustic spectrum is a to-be-determined spectrum value, and a spectrum value below the psychoacoustic spectrum is a masked spectrum value.

Step 3043: Determine, based on the to-be-determined spectrum value, the target spectrum value that needs to be quantized in the sub-band.

After the to-be-determined spectrum value is determined, a total quantity of bits consumed by the to-be-determined spectrum value may be obtained, whether to dynamically adjust the initial value is determined based on the value relationship between the total quantity of bits and the quantity of available bits, and the psychoacoustic spectrum envelope coefficient is dynamically adjusted when it is determined that the initial value needs to be dynamically adjusted. In addition, based on an application requirement, the process may include at least one of a first adjustment process and a second adjustment process provided in embodiments of the present disclosure. In addition, when the process of dynamically adjusting the psychoacoustic spectrum envelope coefficient includes the first adjustment process and the second adjustment process, the first adjustment process may be performed before the second adjustment process, and the second adjustment process is adjusted based on the first adjustment process. In the first adjustment process, the total quantity of bits consumed by the to-be-determined spectrum value is determined through estimation, and adjustment precision is low. Therefore, the first adjustment process can also be referred to as a coarse adjustment process. In the second adjustment process, the to-be-determined spectrum value is quantized, and the total quantity of bits consumed by the to-be-determined spectrum value is determined based on bits that need to be consumed for encoding the quantized to-be-determined spectrum value. Therefore, the second adjustment process is also referred to as a fine adjustment process. In addition, when the second adjustment process provided in embodiments of the present disclosure is not used for adjustment, fine adjustment may be performed in another adjustment manner, so that bit allocation can meet a requirement of the target bit rate. For example, fine adjustment may be performed, based on another requirement, on an adjustment manner of quantizing the spectrum value in the adjustment process, to ensure adjustment precision.

An implementation of the adjustment process is described below by using an example in which the process of dynamically adjusting the psychoacoustic spectrum envelope coefficient includes the first adjustment process and the second adjustment process.

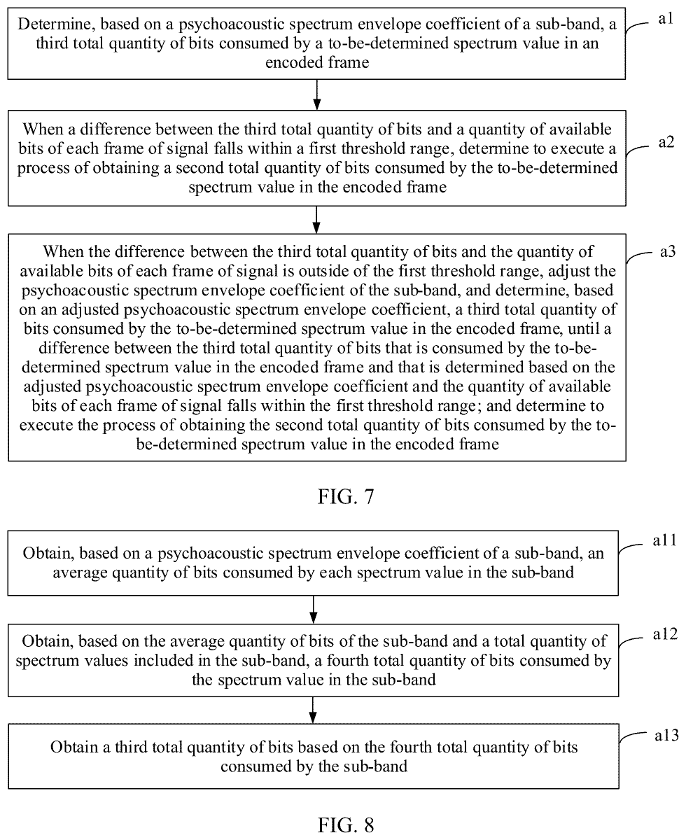

As shown in FIG. 7, the first adjustment process includes the following steps.

Step a1: Determine, based on the psychoacoustic spectrum envelope coefficient of the sub-band, a third total quantity of bits consumed by the to-be-determined spectrum value in the encoded frame.

In a possible implementation, as shown in FIG. 8, an implementation process of step a1 includes the following steps.

Step a11: Obtain, based on the psychoacoustic spectrum envelope coefficient of the sub-band, an average quantity of bits consumed by each spectrum value in the sub-band.

In a possible implementation, quantization level measurement factors of the spectrum values in the sub-band may be obtained based on the psychoacoustic spectrum envelope coefficients of the sub-bands, and an average quantity of bits consumed by spectrum values at different quantization levels are obtained based on quantization levels indicated by the quantization level measurement factors. Optionally, a correspondence between a quantization level and an average quantity of bits consumed by a spectrum value at the quantization level may be obtained in advance. After a quantization level measurement factor of a spectrum value is determined, the correspondence may be queried based on the quantization level measurement factor, to obtain an average quantity of bits consumed by the spectrum value at a corresponding quantization level. For example, quantities of bits consumed by the spectrum values at the different quantization levels may be counted in an entropy encoding process, and the correspondence is obtained based on a statistical result. For example, a quantization level measurement factor qs(i) of the i^{th} sub-band indicates a quantization level for quantizing a spectrum value on the i^{th} sub-band, and the quantization level measurement factor qs(i) and an average quantity of bits bitps consumed by the spectrum value at the quantization level may meet the following correspondence:

$$bitps = \{ \begin{matrix}0 , qs ( i ) = 0 \\ 0.96 , qs ( i ) = 1 \\ 0.19 , qs ( i ) = 2 \\ 2.79 , qs ( i ) = 3 \\ 0.93 + ( qs ( i ) - 3 ) , qs ( i ) > 3\end{matrix}$$

Optionally, the quantization level measurement factor may be obtained based on the psychoacoustic spectrum envelope coefficient and the scale factor of the sub-band. In an implementation, the quantization level measurement factor may be obtained based on a difference between the scale factor and the psychoacoustic spectrum envelope coefficient of the sub-band. For example, the difference between the scale factor and the psychoacoustic spectrum envelope coefficient of the sub-band may be determined as the quantization level measurement factor. Because the quantization level measurement factor indicates the quantization level, and the quantization level should be represented by using a positive number, when the quantization level measurement factor is determined based on the difference between the scale factor and the psychoacoustic spectrum envelope coefficient of the sub-band, the quantization level measurement factor may be determined based on a larger value between the difference and 0. For example, the scale factor E(i), the psychoacoustic spectrum envelope coefficient psySF(i), and the quantization level measurement factor qs(i) of the i^{th} sub-band may satisfy Formula 2:

qs(i)=MAX(E(i)−psySF(i),0)

A value of i is an integer in [0, B−1]. B is a total quantity of sub-bands of the audio signal. Optionally, the B sub-bands may be specifically the sub-bands that need to be encoded in the sub-bands of the audio signal, for example, the sub-bands that need to be encoded and that are obtained based on the cut-off frequency of the audio signal.

Step a12: Obtain, based on the average quantity of bits of the sub-band and a total quantity of spectrum values included in the sub-band, a fourth total quantity of bits consumed by the spectrum value in the sub-band.

After the average quantity of bits consumed by each spectrum value in the sub-band is obtained, the total quantity of spectrum values included in the sub-band (namely, a total quantity of frequencies included in the sub-band) may be determined, and then the fourth total quantity of bits consumed by the spectrum value in the sub-band is determined based on the average quantity of bits and the total quantity. In an implementation, for any sub-band, a product of an average quantity of bits consumed by each spectrum value in the sub-band and a total quantity of spectrum values included in the sub-band may be determined as a fourth total quantity of bits consumed by the spectrum value in the sub-band.

Step a13: Obtain the third total quantity of bits based on the fourth total quantity of bits consumed by the sub-band.

After a fourth total quantity of bits consumed by spectrum values in each sub-band is obtained, the third total quantity of bits consumed by the to-be-determined spectrum value in the encoded frame may be determined based on a sub-band included in each frame of signal. In an implementation, a sum of fourth total quantities of bits of a plurality of sub-bands included in each frame of signal may be determined as the third total quantity of bits.

Step a2: When a difference between the third total quantity of bits and the quantity of available bits of each frame of signal falls within a first threshold range, determine to execute a process of obtaining the second total quantity of bits consumed by the to-be-determined spectrum value in the encoded frame, that is, execute the second adjustment process.

When the difference between the third total quantity of bits and the quantity of available bits of each frame of signal falls within the first threshold range, it indicates that a masking degree of the current psychoacoustic spectrum on the spectra of the audio signal can basically meet a requirement of the target bit rate, and the second adjustment process may be performed to finely adjust the psychoacoustic spectrum. This obtains an accurate psychoacoustic spectrum. It should be noted that, when the adjustment process includes only the first adjustment process, step a2 is as follows: When a difference between the third total quantity of bits and the quantity of available bits of each frame of signal falls within a first threshold range, determine the to-be-determined spectrum value as the target spectrum value. The first threshold range may be determined based on a sound quality requirement for the audio signal. For example, within a range in which sound quality is allowed to be interfered, the first threshold range may be [−10 bits, 10 bits]. For another example, in a scenario that has a strict requirement on a bit rate, the first threshold range may include only 0, that is, that the difference between the third total quantity of bits and the quantity of available bits of each frame of signal is within the first threshold range means that the third total quantity of bits is equal to the quantity of available bits of each frame of signal.

Step a3: When the difference between the third total quantity of bits and the quantity of available bits of each frame of signal is outside of the first threshold range, adjust the psychoacoustic spectrum envelope coefficient of the sub-band, and determine, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determine to execute the process of obtaining the second total quantity of bits consumed by the to-be-determined spectrum value in the encoded frame.

It should be noted that, when the adjustment process includes only the first adjustment process, step a3 is as follows: When the difference between the third total quantity of bits and the quantity of available bits of each frame of signal is outside of the first threshold range, adjust the psychoacoustic spectrum envelope coefficient of the sub-band; determine, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determine the to-be-determined spectrum value as the target spectrum value.

In an implementation, that the psychoacoustic spectrum envelope coefficient of the sub-band is adjusted; and the third total quantity of bits consumed by the to-be-determined spectrum value in the encoded frame is determined based on the adjusted psychoacoustic spectrum envelope coefficient includes the following steps.

Step a31: Adjust the psychoacoustic spectrum envelope coefficient of the sub-band in the audio signal in a second adjustment manner.

The second adjustment manner indicates a manner of adjusting the psychoacoustic spectrum envelope coefficient, and includes adjusting an adjustment amplitude of the psychoacoustic spectrum envelope coefficient of each sub-band, a priority sequence of the psychoacoustic spectrum envelope coefficients of the plurality of sub-bands, and the like. In a possible implementation, the second adjustment manner is obtained based on the target bit depth. For example, as described above, the value range, an initial value, and a step length of the dynamic adjustment factor may be determined based on the target bit depth. In addition, the first adjustment process may also include a coarse adjustment process and a fine adjustment process. In addition, to improve an adjustment speed, the coarse adjustment process may be first performed, and then the fine adjustment process is performed. In the coarse adjustment process, the psychoacoustic spectrum envelope coefficient is adjusted based on the dynamic adjustment factor. In the fine adjustment process, the psychoacoustic spectrum envelope coefficient is adjusted based on an auxiliary adjustment factor. In addition, the auxiliary adjustment factor may also be obtained based on the target bit depth.

The example in step 303 is still used. When the target bit depth is 24 bits, the value range of the dynamic adjustment factor is the integers in [−8, 23]. To ensure the adjustment speed, the initial value of the dynamic adjustment factor may be set to a maximum value 23 in the value range. In addition, according to a principle of finer adjustment, an initial value of the step length of the dynamic adjustment factor may be set to a span 32 of the value range, and the step length is reduced by one time after each adjustment, that is, the step length step=step/2.

Because the psychoacoustic spectrum envelope coefficient is adjusted based on the auxiliary adjustment factor in the fine adjustment process, a value of the auxiliary adjustment factor may be determined by using a span representing a decimal part in the value range of the dynamic adjustment factor. That is, when the value range of the dynamic adjustment factor is the integers in [−8, 23], the auxiliary adjustment factor may have eight values and are integers in [0, 7] respectively. In addition, because the high frequency audio signal is slightly less important than the low and medium frequency audio signal, the psychoacoustic spectrum envelope coefficients of high and medium frequency sub-bands may be preferably adjusted in the adjustment process. In this case, an initial value of the auxiliary factor may be 7, and decreases in each adjustment process, that is, the auxiliary adjustment factor may change in a sequence of 7, 6, 5, 4, 3, 2, 1, and 0.

Optionally, when the difference between the third total quantity of bits and the quantity of available bits of each frame of signal is greater than a maximum value of the first threshold range, for example, when the third total quantity of bits is greater than the quantity of available bits of each frame of signal, it indicates that the compression efficiency is insufficient. In this case, the second adjustment manner may indicate to increase the psychoacoustic spectrum envelope coefficient of the sub-band in the audio signal, to decrease a width between a spectrum envelope of the audio signal and a psychoacoustic spectrum envelope, and decrease a quantity of frequencies included between the spectrum envelope of the audio signal and the psychoacoustic spectrum envelope. This implements effect of improving the compression efficiency. Alternatively, when the difference between the third total quantity of bits and the quantity of available bits of each frame of signal is less than a minimum value of the first threshold range, for example, when the third total quantity of bits is less than the quantity of available bits of each frame of signal, it indicates that the compression efficiency is excessively high. In this case, the second adjustment manner may indicate to decrease the psychoacoustic spectrum envelope coefficient of the sub-band in the audio signal, to increase a width between a spectrum envelope of the audio signal and a psychoacoustic spectrum envelope, and increase a quantity of frequencies included between the spectrum envelope of the audio signal and the psychoacoustic spectrum envelope. This implements effect of reducing the compression efficiency.

In addition, the second adjustment manner indicates to adjust a psychoacoustic spectrum envelope coefficient of a fourth sub-band in the audio signal after adjustment of a psychoacoustic spectrum envelope coefficient of a third sub-band in the audio signal is completed, and a frequency of the third sub-band is higher than a frequency of the fourth sub-band. That is, the second adjustment manner indicates that an adjustment principle is as follows: A psychoacoustic spectrum coefficient of a high frequency sub-band in the audio signal is first adjusted, and then a psychoacoustic spectrum coefficient of a low frequency sub-band in the audio signal is adjusted.

In addition, the second adjustment manner may further indicate to first adjust the psychoacoustic spectrum envelope coefficient of the sub-band based on the dynamic adjustment factor, and then adjust the psychoacoustic spectrum envelope coefficient of the sub-band based on the auxiliary adjustment factor. Because an adjustment amplitude corresponding to the dynamic adjustment factor is larger, an adjustment amplitude corresponding to the auxiliary adjustment factor is smaller, and the psychoacoustic spectrum envelope coefficient needs to be adjusted greatly in the first adjustment process, the dynamic adjustment factor is first used and then the auxiliary adjustment factor is used for adjustment. This can effectively ensure an adjustment rate of the psychoacoustic spectrum envelope coefficient of the sub-band.

Step a32: Update the to-be-determined spectrum value based on the adjusted psychoacoustic spectrum envelope coefficient.

Each time after the psychoacoustic spectrum envelope coefficient is adjusted, the to-be-determined spectrum value may be updated based on an adjusted psychoacoustic spectrum envelope coefficient. For an implementation process thereof, refer to related descriptions in step 3042. Details are not described herein again.

Step a33: Obtain, based on an updated to-be-determined spectrum value, a third total quantity of bits consumed by the updated to-be-determined spectrum value in the encoded frame.

After each update of the to-be-determined spectrum value, the third total quantity of bits consumed by the updated to-be-determined spectrum value may be obtained based on the updated to-be-determined spectrum value. For an implementation process thereof, refer to related descriptions in step a1. Details are not described herein again.

The first adjustment process is described below by using an adjustment process as an example. The first adjustment process includes the following steps.

Step S11: Obtain a plurality of sub-bands of an audio signal and a scale factor of each sub-band, where a scale factor of an i^{th} sub-band is E(i).

Step S12: Obtain a target bit rate and a frame length, obtain, based on the target bit rate and the frame length, a total quantity of bits bitTarget that can be used for transmitting frames of signals, obtain a target bit depth of 24 bits, and determine, based on the bit depth, that an initial value of a dynamic adjustment factor dr=23, an initial step step length of the dynamic adjustment factor=32, an update manner of the step step length of the dynamic adjustment factor is step=step/2, a value range of the dynamic adjustment factor is integers in [−8, 23], an initial value of an auxiliary adjustment factor drQuater=7, a step length of the auxiliary adjustment factor is −1, and a value range of the auxiliary adjustment factor is integers in [0, 7].

Step S13: Obtain a static adjustment factor of each sub-band, where a static adjustment factor of the i^{th} sub-band is dr_{adjust}(i).

Step S14: Calculate, based on current dr and dr_{adjust}( ) of each sub-band, a psychoacoustic spectrum envelope coefficient psySF(i) of each sub-band according to Formula 1, and calculate, based on the psychoacoustic spectrum envelope coefficient psySF(i) and the scale factor E(i) of each sub-band, a quantization level measurement factor qs(i) of each sub-band according to Formula 2.

Step S15: Estimate, based on the quantization level measurement factor qs(i) of each sub-band, a total quantity of frequencies included in the sub-band, and a sub-band included in each frame, a total quantity of bits bits that need to be consumed for encoding the frames of signals, and reduce the step length based on step=step/2. Then, that bit allocation meets a requirement is determined. If bits>bitTarget, the psychoacoustic spectrum envelope coefficient of the sub-band in the audio signal needs to be increased in next update, that is, dr is updated to dr+step. Alternatively, if bits<bitTarget, the psychoacoustic spectrum envelope coefficient of the sub-band in the audio signal needs to be decreased in next update, that is, dr is updated to dr−step.

It should be noted that when dr is updated based on the step length, a range of dr may be limited. In an implementation, when the range of dr is limited, updated dr may be controlled not to exceed the value range of dr. For example, updated dr, and a minimum value SF_BIT_MIN and a maximum value SF_BIT_MAX in the value range of dr may satisfy:

dr=max(min(dr,SF_BIT_MAX),SF_BIT_MIN).

Step S16: Execute the first adjustment process based on updated dr, that is, perform step S14 and step S15 until six cycles are performed, and the step step length is updated to 0; and if bit allocation still does not meet the requirement, bit allocation adjustment is performed on high and low frequencies based on the auxiliary adjustment factor drQuater, that is, a bit proportion of high frequencies is compressed and a bit proportion of low frequencies is increased. After a round of adjustment is completed based on the auxiliary adjustment factor drQuater, if bit allocation still does not meet the requirement, it indicates that great adjustment needs to be performed. Therefore, dr continues to be updated. In this case, a manner of dr is updated to be that dr=dr−1, and step S14 and step S15 are performed based on updated dr. If bit allocation still does not meet the requirement, drQuater=drQuater−1 is updated, and a cycle of adjustment still based on an updated auxiliary adjustment factor drQuater is entered. Until bit allocation meets the requirement (to be specific, that bits=bitTarget is met), the cycle is exited, and the first adjustment process is completed. Alternatively, when an extreme condition (step==0, drQuater==0, and dr==SF_BIT_MIN) is met, the first adjustment process ends. That the auxiliary adjustment factor drQuater completes a round of adjustment means that values in the value range of drQuater are traversed during update of drQuater, and updated drQuater is used to perform the adjustment process. The extreme condition indicates that the spectrum values are compressed enough, but the bits are still less than bitTarget. In this case, to ensure the sound quality, the first adjustment process may end.

The process of adjusting bit allocation for the high and low frequencies based on the auxiliary adjustment factor drQuater includes the following steps: Find out all frequencies that are not quantized to 0 from all frequencies of the audio signal, and count a total quantity of the frequencies. Find out frequencies whose quantity is (the total quantity of frequencies×drQuater/a total quantity of values of drQuater) from all the frequencies that are not quantized to 0 at a high frequency to a low frequency (For example, when drQuater is 7, its value range is integers in [0, 7], and when the total quantity of values is 8, drQuater/the total quantity of values is 7/8). Then, determine a sub-band where each found frequency is located, update psySF(i) of each sub-band based on updated psySF(i)=psySF(i)+1, and update the quantization level measurement factor qs(i) of each sub-band based on updated qs(i)=qs(i)−1. Then, estimate the bits based on updated psySF(i) and qs(i), and determine, based on the bits, whether the bits meet the requirement. When bits=bitTarget, exit the cycle, and complete the first adjustment process. When bits<bitTarget, update drQuater to drQuater−1. Then, adjust psySF(i) and qs(i) based on updated drQuater, estimate bits based on adjusted psySF(i) and qs(i), and perform a process of determining, based on the bits, whether the bits meet the requirement.

When bit allocation adjustment is performed on the high and low frequencies based on the auxiliary adjustment factor drQuater, adjusting frequencies from the high frequency to the low frequency are actually adjusting the psychoacoustic spectrum coefficient of the high frequency sub-band in the audio signal first, and then adjusting the psychoacoustic spectrum coefficient of the low frequency sub-band in the audio signal. This can ensure that bits are preferably allocated to low and medium frequency spectrum values carrying more important information, ensure that the more important information can be transmitted to the audio receiving device, and ensure the sound quality.

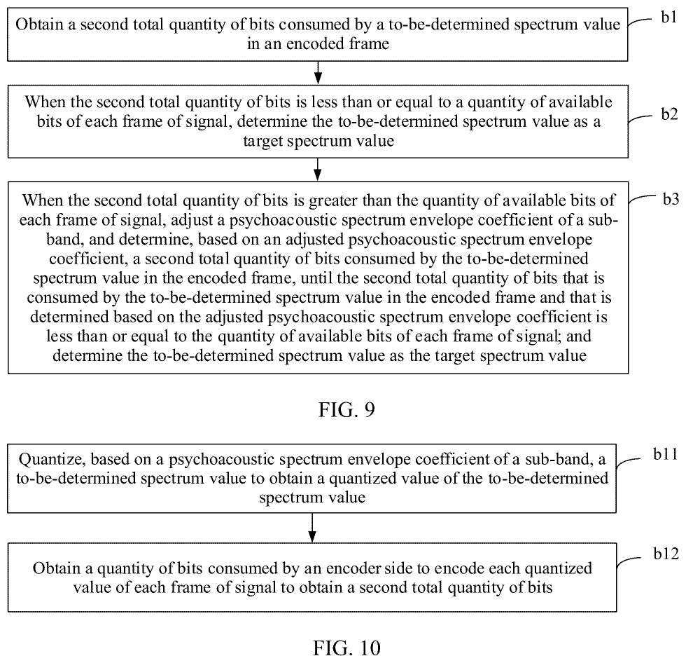

As shown in FIG. 9, the second adjustment process includes the following steps.

Step b1: Obtain a second total quantity of bits consumed by the to-be-determined spectrum value in the encoded frame.

In a possible implementation, as shown in FIG. 10, an implementation process of step b1 includes the following steps.

Step b11: Quantize, based on the psychoacoustic spectrum envelope coefficient of the sub-band, the to-be-determined spectrum value to obtain a quantized value of the to-be-determined spectrum value.

When the first adjustment process is executed, the psychoacoustic spectrum envelope coefficient used in step b11 is the psychoacoustic spectrum envelope coefficient psySF(i) when the first adjustment process ends. When the first adjustment process is not executed, the psychoacoustic spectrum envelope coefficient used in step b11 is the psychoacoustic spectrum envelope coefficient psySF(i) of the sub-band determined in step 303.

Quantization is to convert a floating-point spectrum value into an integer value, so as to facilitate packaging of a subsequent encoded bitstream. In embodiments of the present disclosure, the spectrum value may be quantized based on an in-band masking function of the psychoacoustic spectrum on the spectrum value and quantization precision determined by the psychoacoustic spectrum envelope coefficient respectively, and then the quantized value of the to-be-determined spectrum value is determined based on quantization results of the two.

Quantization precision is inversely correlated with the psychoacoustic spectrum envelope coefficient. For example, background noise of the sub-band may be determined based on the psychoacoustic spectrum envelope coefficient of the sub-band, and a magnitude of the background noise may reflect quantization precision. Smaller background noise indicates higher quantization precision. For example, the psychoacoustic spectrum envelope coefficient psySF(i) and the background noise NF(i) of the i^{th} sub-band may satisfy:

NF(i)=2^{psySF(i)},i∈[0,B−1]

In an implementation, for the i^{th} sub-band, when a spectrum value X(k) of a k^{th} frequency in the sub-band is quantized based on an in-band masking function of a psychoacoustic spectrum on the spectrum value, a quantization level measurement factor qs(i) of the i^{th} sub-band may be first obtained based on the psychoacoustic spectrum envelope coefficient psySF(i) of the i^{th} sub-band, and then the spectrum value is quantized based on the quantization level measurement factor qs(i).

A first quantized value X_{qs}(k) of the spectrum value X(k), the quantization level measure factor qs(i), and the spectrum value X(k) in the i^{th} sub-band may satisfy:

X_{qs}(k)=2^{qs(i)}−1,i∈[0,B−1]

A value of i is an integer in [0, B−1]. B is a total quantity of sub-bands of the audio signal. Optionally, the B sub-bands may be specifically the sub-bands that need to be encoded in the sub-bands of the audio signal, for example, the sub-bands that need to be encoded and that are obtained based on the cut-off frequency of the audio signal.

When the spectrum value is quantized based on quantization precision, the spectrum value X(k) in the i^{th} sub-band, the psychoacoustic spectrum envelope coefficient psySF(i) of the i^{th} sub-band, and a second quantized value X_{qn}(k) of the spectrum value X(k) may satisfy:

$${X}_{qm} ( k ) = int ( \frac{\vert X ( k ) \vert}{{2}^{psySF ( i )}} + c ) , i ∈ [ 0 , B - 1 ] , bandstart [ i ] < k < bandend [ i ]$$

A value of i is an integer in [0, B−1]. B is a total quantity of sub-bands of the audio signal. Optionally, the B sub-bands may be specifically the sub-bands that need to be encoded in the sub-bands of the audio signal, for example, the sub-bands that need to be encoded and that are obtained based on the cut-off frequency of the audio signal. |X(k)| indicates an absolute value of X(k), bandstart[i] indicates a first frequency in the i^{th} sub-band, and bandend[i] indicates a last frequency in the i^{th} sub-band, int(x) indicates rounding down x, and

c is a parameter for performing truncation processing on the spectrum value. In an implementation, when the quantization level measurement factor qs(i) of the i^{th} sub-band is 1, a value of c may be 0.375. When the quantization level measurement factor qs(i) of the i^{th} sub-band is another value, a value of c may be 0.5. In this case, truncation processing on the spectrum value is equivalent to rounding off the spectrum value. It should be noted that a value of c may be determined based on requirements of the decoder side on sound quality and compression efficiency, and may be adjusted based on a requirement in an application process.

After the first quantized value and the second quantized value of the to-be-determined spectrum value are determined, according to a principle of saving compressed bits, the quantized value of the to-be-determined spectrum value may be determined based on a smaller one of the first quantized value and the second quantized value. For example, the smaller one is determined as the quantized value of the to-be-determined spectrum value. In addition, because the quantized value is integer data, in order to ensure that the to-be-determined spectrum value is not quantized to a negative number, a larger one of the smaller one and 0 may be determined as the quantized value of the to-be-determined spectrum value. For example, the quantized value X_{q}(k) of the to-be-determined spectrum value, the first quantized value X_{qs}(k) thereof, and the second quantized value X_{qm}(k) thereof may satisfy the following formula:

X_{q}(k)=MAX(MIN((X_{qs}(k),X_{qn}(k))),0)bandstart[i]<k<bandend[i],i∈[0,B−1]

In addition, when the spectrum value is 0, a sign bit of the quantized value of the spectrum value is 0, and the sign bit is not transmitted in the encoded bitstream. Further, when the spectrum value is a positive number, a sign bit of the quantized value of the spectrum value is 1, and the sign bit needs to be transmitted in the encoded bitstream, to indicate a symbol of the spectrum value. Alternatively, when the spectrum value is a negative number, a sign bit of the quantized value of the spectrum value is 0, and the sign bit needs to be transmitted in the encoded bitstream, to indicate a symbol of the spectrum value.

Step b12: Obtain a quantity of bits consumed by the encoder side to encode each quantized value of each frame of signal to obtain the second total quantity of bits.

In an implementation, a codebook may indicate a manner of encoding the quantized value, for example, may indicate a correspondence between the quantized value and an encoded value after the quantized value is encoded, and indicate a quantity of bits consumed by the encoded value. In this case, the codebook for encoding the quantized value may be queried based on the quantized value, so as to obtain the quantity of bits consumed by each quantized value, and then a sum of quantities of bits consumed by all quantized values is determined as the second total quantity of bits.

Step b2: When the second total quantity of bits is less than or equal to the quantity of available bits of each frame of signal, determine the to-be-determined spectrum value as the target spectrum value.

When the second total quantity of bits is less than or equal to the quantity of available bits of each frame of signal, it indicates that the masking degree of the current psychoacoustic spectrum on the spectra of the audio signal can meet the requirement of the target bit rate. In this case, the spectrum value of the audio signal may be encoded based on the psychoacoustic spectrum, and the to-be-determined spectrum value may be determined as the target spectrum value.

Step b3: When the second total quantity of bits is greater than the quantity of available bits of each frame of signal, adjust the psychoacoustic spectrum envelope coefficient of the sub-band, and determine, based on an adjusted psychoacoustic spectrum envelope coefficient, a second total quantity of bits consumed by the to-be-determined spectrum value in the encoded frame, until the second total quantity of bits that is consumed by the to-be-determined spectrum value in the encoded frame and that is determined based on the adjusted psychoacoustic spectrum envelope coefficient is less than or equal to the quantity of available bits of each frame of signal; and determine the to-be-determined spectrum value as the target spectrum value.

In an implementation, that the psychoacoustic spectrum envelope coefficient of the sub-band is adjusted; and the second total quantity of bits consumed by the to-be-determined spectrum value in the encoded frame is determined based on the adjusted psychoacoustic spectrum envelope coefficient includes the following steps.

Step b31: Adjust the psychoacoustic spectrum envelope coefficient of the sub-band in the audio signal in a first adjustment manner.

In an implementation, the first adjustment manner is obtained based on the target bit depth.

The first adjustment manner indicates a manner of adjusting the psychoacoustic spectrum envelope coefficient, and includes adjusting an adjustment amplitude of the psychoacoustic spectrum envelope coefficient of each sub-band, a priority sequence of the psychoacoustic spectrum envelope coefficients of the plurality of sub-bands, and the like. The second adjustment process may also include a coarse adjustment process and a fine adjustment process. In addition, to ensure adjustment precision, the fine adjustment process may be first performed, and then the coarse adjustment process is performed. In the coarse adjustment process, the psychoacoustic spectrum envelope coefficient is adjusted based on the dynamic adjustment factor. In the fine adjustment process, the psychoacoustic spectrum envelope coefficient is adjusted based on an auxiliary adjustment factor.

In a possible implementation, the first adjustment manner is obtained based on the target bit depth. For example, as described above, the value range and the step length of the dynamic adjustment factor and the value range and the step length of the auxiliary adjustment factor may be determined based on the target bit depth. The example in step 303 is still used. When the target bit depth is 24 bits, the value range of the dynamic adjustment factor is integers in [−8, 23], and to ensure adjustment precision, the step length of the dynamic adjustment factor may be set to 1.

Because the psychoacoustic spectrum envelope coefficient is adjusted based on the auxiliary adjustment factor in the fine adjustment process, a value of the auxiliary adjustment factor may be determined by using a span representing a decimal part in the value range of the dynamic adjustment factor. That is, when the value range of the dynamic adjustment factor is the integers in [−8, 23], the auxiliary adjustment factor may have eight values and are integers in [0, 7] respectively. In addition, to ensure adjustment precision, the step length of the auxiliary adjustment factor may be set to 1. It should be noted that, when the first adjustment process is executed, an initial value of the dynamic adjustment factor in the second adjustment process is a value of the dynamic adjustment factor when the first adjustment process ends, and an initial value of the auxiliary adjustment factor is a value of the auxiliary adjustment factor when the first adjustment process ends. When the first adjustment process is not executed, for an initial value of the dynamic adjustment factor in the second adjustment process, refer to an initial value of the dynamic adjustment factor in the first adjustment process, and for an initial value of the auxiliary adjustment factor in the second adjustment process, refer to an initial value of the auxiliary adjustment factor in the first adjustment process. Determining manners of the initial values are not described herein again.

In addition, when the first adjustment process is executed, because the spectrum value needs to be quantized in the second adjustment process, a total quantity of bits consumed by a quantized spectrum value is generally greater than a total quantity of bits estimated in the first adjustment process. Therefore, in the second adjustment process, the psychoacoustic spectrum envelope coefficient needs to be increased, that is, when the dynamic adjustment factor and the auxiliary adjustment factor are updated, the dynamic adjustment factor and the auxiliary adjustment factor need to be increased on the whole.

Optionally, when the first adjustment manner indicates to increase the psychoacoustic spectrum envelope coefficient of the sub-band in the audio signal when the second total quantity of bits is greater than the quantity of available bits of each frame of signal, which indicates that the compression efficiency is insufficient, to decrease a width between a spectrum envelope of the audio signal and a psychoacoustic spectrum envelope, and decrease a quantity of frequencies included between the spectrum envelope of the audio signal and the psychoacoustic spectrum envelope. This implements effect of improving the compression efficiency.

In addition, the first adjustment manner indicates to adjust a psychoacoustic spectrum envelope coefficient of a second sub-band in the audio signal after adjustment of a psychoacoustic spectrum envelope coefficient of a first sub-band in the audio signal is completed, and a frequency of the first sub-band is higher than a frequency of the second sub-band. That is, the first adjustment manner indicates that an adjustment principle is as follows: A psychoacoustic spectrum coefficient of a high frequency sub-band in the audio signal is first adjusted, and then a psychoacoustic spectrum coefficient of a low frequency sub-band in the audio signal is adjusted.

In addition, the first adjustment manner may further indicate to first adjust the psychoacoustic spectrum envelope coefficient of the sub-band based on the auxiliary adjustment factor, and then adjust the psychoacoustic spectrum envelope coefficient of the sub-band based on the dynamic adjustment factor. Because an adjustment amplitude corresponding to the dynamic adjustment factor is larger, an adjustment amplitude corresponding to the auxiliary adjustment factor is smaller, and in the second adjustment process, a quantization process of the spectrum value needs to be adjusted and the psychoacoustic spectrum envelope coefficient needs to be adjusted in a small range, the auxiliary adjustment factor is first used and then the dynamic adjustment factor is used for adjustment. This can effectively ensure precision of adjusting the psychoacoustic spectrum envelope coefficient of the sub-band.

Step b32: Update the to-be-determined spectrum value based on the adjusted psychoacoustic spectrum envelope coefficient.

Each time after the psychoacoustic spectrum envelope coefficient is adjusted, the to-be-determined spectrum value may be updated based on an adjusted psychoacoustic spectrum envelope coefficient. For an implementation process thereof, refer to related descriptions in step 3042. Details are not described herein again.

Step b33: Obtain, based on an updated to-be-determined spectrum value, a second total quantity of bits consumed by the updated to-be-determined spectrum value in the encoded frame.

After each update of the to-be-determined spectrum value, the second total quantity of bits consumed by the updated to-be-determined spectrum value may be obtained based on the updated to-be-determined spectrum value. For an implementation process thereof, refer to related descriptions in step b1. Details are not described herein again.

One adjustment process is used as an example below to describe a second adjustment process executed based on a first adjustment process. The second adjustment process includes the following steps.

Step S21: Quantize a to-be-determined spectrum value in each sub-band based on a psychoacoustic spectrum envelope coefficient psySF(i) of each sub-band, to obtain a quantized value of the to-be-determined spectrum value. For an implementation of the process, refer to related descriptions in step b11.

Step S22: Based on a codebook for entropy encoding of the quantized value of the to-be-determined spectrum value, query to obtain bits for entropy encoding, and superimpose bits required by all frequencies in each frame to obtain a quantity of bits consumed for encoding each quantized value of each frame of signal, so as to obtain a second total quantity of bits bits.

Step S23: Determine whether bit allocation meets a requirement; and if bits≤bitTarget, it indicates that bit allocation meets the requirement, and the second adjustment process may end; otherwise, the following fine-tuning process is entered.

When drQuater when the first adjustment process ends is not equal to 7, adjustment is performed in a process of adjustment based on drQuater in the first adjustment process, and then steps S21 to S23 are performed based on updated psySF(i) and qs(i). When bit allocation meets the requirement, the second adjustment process ends; otherwise, drQuater=drQuater+1 is updated. If updated drQuater is not equal to 7, the process of adjustment based on drQuater continues; or if drQuater is equal to 7, dr=dr+1 is updated, and then updated dr is used to perform adjustment in the process of adjustment based on dr in the first adjustment process. Then, steps S21 to S23 are performed based on updated psySF(i) and qs(i), and the second adjustment process ends when bit allocation meets the requirement; otherwise, drQuater=0 is updated. Then, the process of adjustment based on drQuater continues, until bits≤bitTarget is met; or when an extreme condition (dr==SF_BIT_MAX) is met, the second adjustment process ends.

It should be noted that, when that bit allocation meets the requirement is determined, whether to end the second adjustment process may be determined based on a range limit of dr. In an implementation, when dr reaches a maximum value SF_BIT_MAX in the value range of dr, if the bits still do not meet the requirement, in this case, to ensure sound quality of the audio signal, the second adjustment process ends.

Step 305: Obtain the quantized value of the target spectrum value based on the target spectrum value.

After the target spectrum value is determined, the quantized value of the target spectrum value may be obtained based on the target spectrum value. When the adjustment process of the psychoacoustic spectrum envelope coefficient includes the second adjustment process, because the to-be-determined spectrum value is quantized in the second adjustment process, and the target spectrum value is obtained by screening the to-be-determined spectrum value, the target spectrum value is actually quantized in the second adjustment process, and a quantized value of the target spectrum value when the second adjustment process ends may be directly determined as the quantized value of the target spectrum value. Alternatively, when the adjustment process of the psychoacoustic spectrum envelope coefficient does not include the second adjustment process, the target spectrum value may be quantized based on the psychoacoustic spectrum envelope coefficient of each sub-band when the first adjustment process ends, to obtain the quantized value of the target spectrum value. For an implementation process thereof, refer to the implementation in step b11.

In conclusion, in the quantization method provided in embodiments of the present disclosure, the psychoacoustic spectrum envelope coefficient of each sub-band is obtained based on the target bit depth for encoding the audio signal and the scale factor of each sub-band; the target spectrum value that needs to be quantized in the sub-band is determined based on the psychoacoustic spectrum envelope coefficient of the sub-band; and then the quantized value of the target spectrum value is obtained based on the target spectrum value, where the first total quantity of bits consumed by the target spectrum value in the encoded frame is less than or equal to the quantity of available bits of each frame of signal, and the quantity of available bits is determined based on the target bit rate that can be used by the encoder side to transmit the audio signal to the decoder side. It can be learned from the descriptions of embodiments of the present disclosure that, the quantization method actually indicates a process of performing bit allocation based on the target bit rate, so as to control quantization precision based on the target bit rate. In addition, the process is implemented by adjusting the psychoacoustic spectrum envelope coefficient of the sub-band, and performing masking guide on the spectrum value in the sub-band based on the psychoacoustic spectrum envelope coefficient. Therefore, quantization is performed according to the quantization method, to help maintain a bit rate of each frame in a constant state based on the target bit rate, improve stability of the bit rate in a transmission process, and further improve anti-interference performance of the encoded bitstream for sending the audio signal.

In addition, in the first adjustment process, because the spectrum value is not quantized, the third total quantity of bits for determining that bit allocation meets the requirement is obtained through estimation. In the second adjustment process, the spectrum value needs to be quantized, and the first total quantity of bits for determining that bit allocation meets the requirement is obtained based on the quantization and encoding processes. Therefore, accuracy is high, and adjustment precision is high. In the process of quantizing the audio signal, the adjustment manner for adjusting the psychoacoustic spectrum coefficient of the sub-band may be determined based on the application requirement.

Embodiments of the present disclosure further provide a quantization method and a dequantization method. The quantization method is applied to an audio sending device, and the dequantization method is applied to an audio receiving device. The quantization method and the dequantization method may be executed when a first total quantity of bits consumed by a target spectrum value in an encoded frame is less than a quantity of available bits of each frame of signal, that is, executed when there are a remaining bit after bit allocation. The target spectrum value may be obtained based on a target bit rate that can be used by an encoder side to transmit an audio signal to a decoder side. In an implementation, the target spectrum value may be obtained according to the foregoing quantization method provided in embodiments of the present disclosure, for example, may be obtained in the foregoing step 301 to step 305. Alternatively, the target spectrum value may be obtained in another manner. This is not specifically limited in embodiments of the present disclosure.

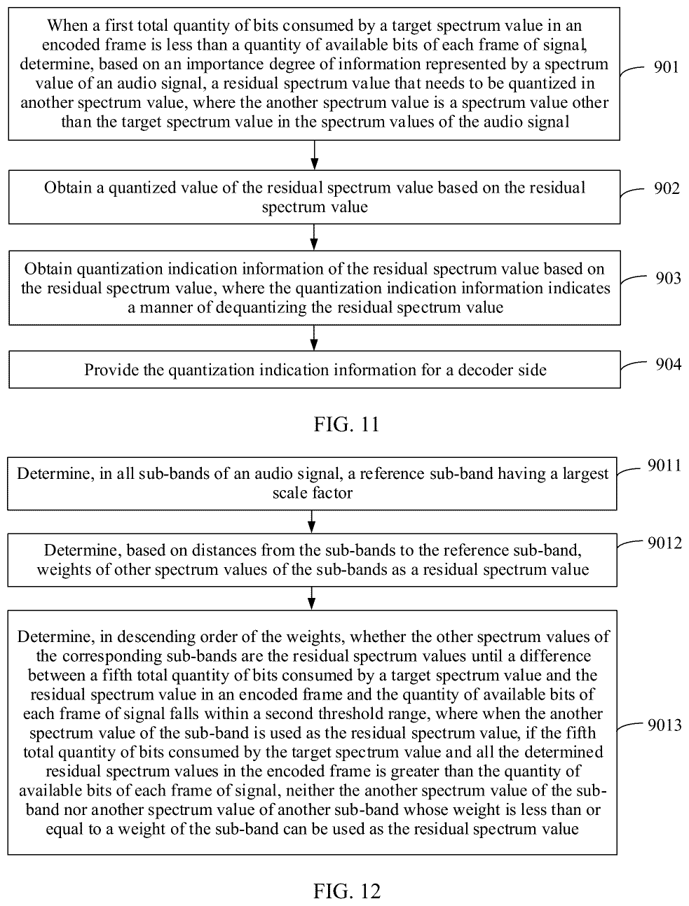

Implementation processes of the quantization method and the dequantization method are described below separately. As shown in FIG. 11, a quantization method includes the following steps.

Step 901: When a first total quantity of bits consumed by a target spectrum value in an encoded frame is less than a quantity of available bits of each frame of signal, determine, based on an importance degree of information represented by a spectrum value of an audio signal, a residual spectrum value that needs to be quantized in other spectrum values, where the other spectrum values are spectrum values other than the target spectrum value in spectrum values of the audio signal.

The target spectrum value may be a spectrum value on which bits are allocated in a bit allocation process, and the another spectrum value is a spectrum value on which bits are not allocated in the bit allocation process. The target spectrum value may be obtained based on a target bit rate that can be used by an encoder side to transmit the audio signal to a decoder side. In an implementation, the target spectrum value may be obtained according to the foregoing quantization method provided in embodiments of the present disclosure, for example, may be obtained in the foregoing step 301 to step 305.

In a possible implementation, the importance degree of information represented by the spectrum value may be reflected by using a scale factor of a sub-band on which a frequency to which the spectrum value belongs is located. As shown in FIG. 12, an implementation process of determining, based on an importance degree of information represented by a spectrum value of an audio signal, a residual spectrum value that needs to be quantized in other spectrum values includes the following steps.

Step 9011: Determine, in all sub-bands of the audio signal, a reference sub-band having a largest scale factor.

When the audio signal is a mono signal, the largest scale factor may be determined from scale factors of the plurality of sub-bands of the mono signal, and a sub-band to which the largest scale factor belongs is the reference sub-band. Alternatively, when the audio signal is a dual-channel signal, the largest scale factor may be determined from scale factors of the plurality of sub-bands of the dual-channel signal, and a sub-band to which the largest scale factor belongs is the reference sub-band. For example, it is assumed that the audio signal is a dual-channel signal, a signal of each channel has 32 sub-bands, and the dual-channel signal has 64 sub-bands in total. A largest scale factor may be determined from 64 scale factors corresponding to the 64 sub-bands, and a sub-band to which the largest scale factor belongs is determined as a reference sub-band.

Step 9012: Determine, based on a distance from each sub-band other than the reference sub-band to the reference sub-band, weight of another spectrum value of the sub-band to be the residual spectrum value.

In an implementation, a weight of any sub-band is inversely correlated with a distance from the any sub-band to the reference sub-band. Optionally, a weight of a sub-band is further obtained based on a condition in which the sub-band is masked by a psychoacoustic spectrum, and a weight of a sub-band masked by the psychoacoustic spectrum is greater than a weight of a sub-band not masked by the psychoacoustic spectrum. For example, weights of all sub-bands not masked by the psychoacoustic spectrum may be set to be less than a weight of a sub-band masked by the psychoacoustic spectrum.

When step 9012 is performed, the plurality of sub-bands of the audio signal may be sorted based on factors that affect the weights of the sub-bands, and weights of different sub-bands are reflected in order of the sub-bands in sorting. For example, when the weights of the sub-bands are obtained based on a condition in which the sub-bands are masked by the psychoacoustic spectrum and the distances from the sub-bands to the reference sub-band, the plurality of sub-bands of the audio signal may be sorted based on the distances and the condition in which the sub-bands are masked by the psychoacoustic spectrum, and it is determined that a weight of a sub-band sorted in the front is greater than a weight of the sub-band sorted in the back. A sorting principle is as follows: Weights of all sub-bands masked by the psychoacoustic spectrum are greater than weights of sub-bands not masked by the psychoacoustic spectrum; in all the sub-bands masked by the psychoacoustic spectrum, a smaller distance to the reference sub-band indicates a larger weight of a sub-band; and in all the sub-bands not masked by the psychoacoustic spectrum, a smaller distance to the reference sub-band indicates a larger weight of a sub-band.

Alternatively, when the plurality of sub-bands are sorted, the weights of the sub-bands may be quantized first based on the condition in which the sub-bands are masked by the psychoacoustic spectrum and the distances between the sub-bands and the reference sub-band, and then the plurality of sub-bands are sorted in descending order of the weights of the sub-bands. In an implementation, a weight band[i] of a sub-band whose index is i in a sorting queue, a distance from the sub-band to the reference sub-band, and a condition in which the sub-band is masked by the psychoacoustic spectrum satisfy the following formula:

$$band [ i ] = \{ \begin{matrix}bandsNum - abs ( \frac{i}{2} - pB ) , & if qs [ i \%2 ] [ i / 2 ] \leq 0 \\ - abs ( \frac{i}{2} - pB ) , & if qs [ i \%2 ] [ i / 2 ] > 0\end{matrix} ,$$

for i=0, 1, . . . , chNum*bandsNum

pB is an index of the reference sub-band. i%2 is a sound channel index. i/2 is an index of a sub-band in a left channel or a right channel. qs[i%2][i/2] represents a quantization level measurement factor of an (i/2)^{th} sub-band of an (i%2)^{th} sound channel. If the quantization level measurement factor of the sub-band is less than or equal to 0, it indicates that the sub-band is masked by the psychoacoustic spectrum; or if the quantization level measurement factor of the sub-band is greater than 0, it indicates that the sub-band is not masked by the psychoacoustic spectrum. bandsNum is a total number of sub-bands in a single sound channel, and chNum is a total number of sound channels. abs(x) indicates an absolute value of x.

After the plurality of sub-bands are sorted based on the weights of the sub-bands, band[i] and the index i may be paired, the sub-bands are sorted in the descending order by using band[i] as a value reference, and a sorting result is recorded in a rank structure array. The rank structure array includes elements a rank[i].val and a rank[i].idx that appear in a pair. The element rank[i].val indicates a value of band[i], and the element rank[i].idx corresponding to the element rank[i].val indicates the index i corresponding to band[i].

Step 9013: Determine, in the descending order of the weights, whether an another spectrum value of a corresponding sub-band is the residual spectrum value until a difference between a fifth total quantity of bits consumed by the target spectrum value and all the residual spectrum value in the encoded frame and the quantity of available bits of each frame of signal falls within a second threshold range, where when the another spectrum value of a sub-band is used as the residual spectrum value, if the fifth total quantity of bits consumed by the target spectrum value and all the determined residual spectrum values in the encoded frame is greater than the quantity of available bits of each frame of signal, neither the another spectrum value of the sub-band nor another spectrum value of another sub-band whose weight is less than or equal to a weight of the sub-band can be used as the residual spectrum value. The second threshold range may be determined based on a sound quality requirement for the audio signal. For example, within a range in which sound quality is allowed to be interfered, the second threshold range may be [−10 bits, 10 bits]. For another example, in a scenario that has a strict requirement on a bit rate, the second threshold range may include only 0, that is, that the difference between the fifth total quantity of bits consumed by the target spectrum value and the residual spectrum value in the encoded frame and the quantity of available bits of each frame of signal falls within the second threshold range means that the fifth total quantity of bits is equal to the quantity of available bits of each frame of signal.

After the weights of the plurality of sub-bands are determined, each other spectrum value in each sub-band may be traversed in the descending order of the weights. When any other spectrum value is traversed, bits consumed for encoding the other spectrum value are determined, then a fifth total quantity of bits consumed for encoding all target spectrum values, all determined residual spectrum values, and the current other spectrum value is determined, and whether the current other spectrum value can be determined as the residual spectrum value is determined based on a value relationship between the fifth total quantity of bits and the quantity of available bits. For example, when one another spectrum value of a sub-band is used as the residual spectrum value, if the fifth total quantity of bits consumed by the target spectrum value and all the determined residual spectrum values in the encoded frame is greater than the quantity of available bits of each frame of signal, neither another spectrum value nor another spectrum value of another sub-band whose weight is less than or equal to a weight of the sub-band can be used as the residual spectrum value.

Step 902: Obtain a quantized value of the residual spectrum value based on the residual spectrum value.

For an implementation of quantizing the residual spectrum value, refer to related descriptions in step b11.

Step 903: Obtain quantization indication information of the residual spectrum value based on the residual spectrum value, where the quantization indication information indicates a manner of dequantizing the residual spectrum value.

The sub-band masked by the psychoacoustic spectrum and the sub-band not masked by the psychoacoustic spectrum each have a different implementation of dequantizing a residual spectrum value of the sub-band. Therefore, after the residual spectrum value is quantized, the quantization indication information of the residual spectrum value further needs to be determined. The implementation of dequantizing the residual spectrum value may be determined based on an amplitude of the residual spectrum value. In addition, to ensure sound quality effect, rounding processing may be performed on the residual spectrum value, and a quantization manner for quantizing the residual spectrum value is determined based on a residual spectrum value on which rounding processing is performed, to obtain the quantization indication information. Optionally, the quantization indication information may be represented by a flag bit, and different flag bits indicate different dequantization manners. In an implementation, for a residual spectrum value m[i%2][i/2] in an (i/2)^{th} sub-band of an (i%2)^{th} sound channel, a flag bit mRes[i%2][i/2] of the residual spectrum value, and a psychoacoustic spectrum envelope coefficient psySF[i%2][i/2] of the (i/2)^{th} sub-band satisfy the following formula.

When qs[i%2][i/2]≤0,

$$mRes [ i \%2 ] [ i / 2 ] = max ( min ( int ( \frac{abs ( m [ i \% 2 ] [ i / 2 ] )}{{2}^{psySF [ i \% 2 ] [ i / 2 ] - 1}} + 0.375 ) , 1 ) , 0 ) .$$

When qs[i%2][i/2]>0,

$$mRes [ i \%2 ] [ i / 2 ] = \{ \begin{matrix}1 , & if abs ( m [ i \%2 ] [ i / 2 ] ) \geq ( mQ [ i \% 2 ] [ i / 2 ] + frac ) * {2}^{psySf [ i \%2 ] [ i / 2 ]} \\ 0 , & else\end{matrix} ,$$

$$where$$

$$\{ \begin{matrix}0.125 , & if qs [ i \%2 ] [ i / 2 ] = 1 \\ 0 , & if qs [ i \%2 ] [ i / 2 ] \neq 1 and qs [ i \%2 ] [ i / 2 ] > 0\end{matrix} .$$

max(x, y) indicates that a larger value between x and y is used, min(x, y) indicates that a smaller value between x and y is used, int(x) indicates rounding down x, and abs(x) indicates an absolute value of x. mQ[i%2][i/2] is a quantized value of the residual spectrum value in the (i/2)^{th} sub-band of the (i%2)^{th} sound channel. qs[i%2][i/2] indicates a quantization level measurement factor of the (i/2)^{th} sub-band of the (i%2)^{th} sound channel. Both 0.375 and 0.125 are offset values for performing rounding processing on the residual spectrum value. A value of the offset value may be determined based on an application requirement, for example, determined based on the application requirement on sound quality, compression efficiency, or the like.

Step 904: Provide the quantization indication information for the decoder side.

After obtaining the quantization indication information of the residual spectrum value, the encoder side needs to provide the quantization indication information for the decoder side, so that the decoder side performs dequantization on a code value based on the quantization indication information.

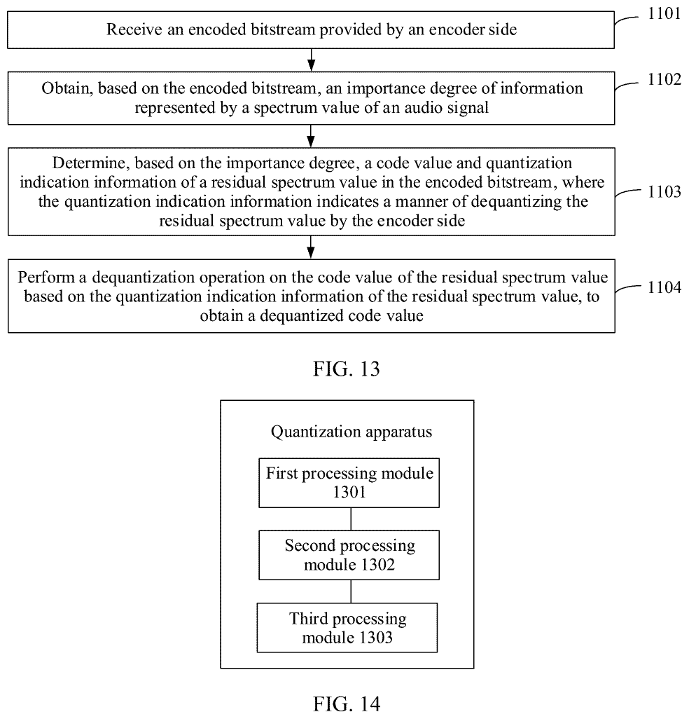

As shown in FIG. 13, a dequantization method includes the following steps.

Step 1101: Receive an encoded bitstream provided by an encoder side.

Step 1102: Obtain, based on the encoded bitstream, an importance degree of information represented by a spectrum value of an audio signal.

In a possible implementation, the importance degree of information represented by the spectrum value may be reflected by using a scale factor of a sub-band on which a frequency to which the spectrum value belongs is located. A larger scale factor of a sub-band indicates more important information represented by a spectrum value in the sub-band. In this case, a scale factor of each sub-band may be obtained by decoding the encoded bitstream, and then the importance degree of the information represented by the spectrum value of the audio signal is determined based on the scale factor of the sub-band.

Step 1103: Determine, based on the importance degree, a code value and quantization indication information of a residual spectrum value in the encoded bitstream, where the quantization indication information indicates a manner of dequantizing the residual spectrum value by the encoder side.

In an implementation, the importance degree is reflected by using the scale factor of the sub-band on which the frequency to which the spectrum value belongs is located. An implementation process of step 1103 may include the following steps.

Step 11031: Determine, in all sub-bands, a reference sub-band having a largest scale factor.

For an implementation process of step 11031, refer to related descriptions in step 9011. Details are not described herein again.

Step 11032: Determine a code value and quantization indication information of a residual spectrum value of a sub-band other than the reference sub-band in the encoded bitstream based on a distance from the sub-band other than the reference sub-band to the reference sub-band.

Locations of the code value and the quantization indication information of the residual spectrum value of the sub-band in the encoded bitstream may be first determined, and then data is read from the corresponding locations, to obtain the code value and the quantization indication information of the residual spectrum value.

In an implementation, the locations of the code value and the quantization indication information of the residual spectrum value of the sub-band in the encoded bitstream may be inversely correlated with a distance from any sub-band to the reference sub-band. For example, when a distance from a first sub-band to the reference sub-band is shorter than a distance from a second sub-band to the reference sub-band, a code value of a residual spectrum value of the first sub-band is before a code value of a residual spectrum value of the second sub-band, and quantization indication information of the residual spectrum value of the first sub-band is before quantization indication information of the residual spectrum value of the second sub-band.

Optionally, the locations of the code value and the quantization indication information of the residual spectrum value of each sub-band in the encoded bitstream are further obtained based on a condition in which the sub-band is masked by a psychoacoustic spectrum. A code value of a residual spectrum value of a sub-band masked by the psychoacoustic spectrum is before a code value of a residual spectrum value of a sub-band not masked by the psychoacoustic spectrum, and quantization indication information of the residual spectrum value of the sub-band masked by the psychoacoustic spectrum is before quantization indication information of the residual spectrum value of the sub-band not masked by the psychoacoustic spectrum. The condition in which the sub-band is masked by the psychoacoustic spectrum is obtained based on the encoded bitstream.

When determining whether other spectrum values of sub-bands become residual spectrum values, the encoder side determines the other spectrum values of the sub-bands in sequence based on weights of the other spectrum values, of the sub-bands, that become the residual spectrum values. When another spectrum value of a sub-band cannot become the residual spectrum value, other spectrum values of all sub-bands whose weights are smaller than that of the sub-band cannot become the residual spectrum values. Therefore, the locations of the code value and the quantization indication information of the residual spectrum value of the sub-band in the encoded bitstream are positively correlated with a weight of the sub-band. For a principle of an implementation of the locations of the code value and the quantization indication information of the residual spectrum value of the sub-band in the encoded bitstream, refer to related descriptions in the quantization method embodiment. Details are not described herein again.

Step 1104: Perform a dequantization operation on the code value of the residual spectrum value based on the quantization indication information of the residual spectrum value, to obtain a dequantized code value.

The quantization indication information indicates a manner of dequantizing the residual spectrum value. After the quantization indication information of the residual spectrum value is obtained, the dequantization operation may be performed on the code value of the residual spectrum value in the dequantization manner indicated by the quantization indication information, so as to obtain the dequantized code value.

In an implementation, if the encoder side performs rounding processing on the residual spectrum value when determining a quantization manner for quantizing the residual spectrum value, an implementation of step 1104 may include the following operations: determining, based on the quantization indication information of the residual spectrum value, an offset value for performing a dequantization operation on the residual spectrum value; and then performing the dequantization operation based on the code value of the residual spectrum value and the offset value to obtain a dequantized code value.

For example, for a residual spectrum value m[i%2][i/2] in an (i/2)^{th} sub-band of an (i%2)^{th} sound channel, a flag bit mRes[i%2][i/2] of the residual spectrum value, and an offset value ResQ[i%2][i/2] of the residual spectrum value satisfy:

When qs[i%2][i/2]≤0,

$$ResQ [ i \%2 ] [ i / 2 ] = \{ \begin{matrix}0.5 , & if mRes [ i \%2 ] [ i / 2 ] = 1 \\ 0 , & if mRes [ i \%2 ] [ i / 2 ] = 0\end{matrix} .$$

When qs[i%2][i/2]>0,

$$ResQ [ i \%2 ] [ i / 2 ] = \{ \begin{matrix}frac + 0.25 , & if mRes [ i \%2 ] [ i / 2 ] = 1 \\ frac - 0.25 , & else\end{matrix} ,$$

$$where$$

$$frac = \{ \begin{matrix}0.125 , & if qs [ i \%2 ] [ i / 2 ] = 1 \\ 0 , & if qs [ i \%2 ] [ i / 2 ] \neq 1 and qs [ i \%2 ] [ i / 2 ] > 0\end{matrix} .$$

qs[i%2][i/2] represents a quantization level measurement factor of the (i/2)^{th} sub-band of the (i%2)^{th} sound channel. All 0.5, 0.25, and 0.125 are offset values for performing rounding processing on the residual spectrum value. A value of the offset value may be determined based on an application requirement, for example, determined based on the application requirement on sound quality, compression efficiency, or the like.

In conclusion, in the quantization method and the dequantization method provided in embodiments of the present disclosure, when the first total quantity of bits consumed by the target spectrum value in the encoded frame is less than the quantity of available bits of each frame of signal, the residual spectrum value that needs to be quantized is determined from another spectrum value based on the importance of information represented by the spectrum value of the audio signal, and the quantized value of the residual spectrum value is obtained based on the residual spectrum value. This can effectively use a remaining bit, maintain a bit rate of each frame in a constant state based on the target bit rate, improve stability of the bit rate in a transmission process, and further improve anti-interference performance of the encoded bitstream for sending the audio signal.

An embodiment of the present disclosure further provides a quantization apparatus. The quantization apparatus is used in an encoder side. As shown in FIG. 14, the quantization apparatus includes a first processing module 1301, a second processing module 1302, and a third processing module 1303.

The first processing module 1301 is configured to obtain a psychoacoustic spectrum envelope coefficient of each sub-band based on a scale factor of each sub-band and a target bit depth for encoding an audio signal.

The second processing module 1302 is configured to determine, based on the psychoacoustic spectrum envelope coefficient of the sub-band, a target spectrum value that needs to be quantized in the sub-band, where a first total quantity of bits consumed by the target spectrum value in an encoded frame is less than or equal to a quantity of available bits of each frame of signal, and the quantity of available bits is determined based on a target bit rate that can be used by the encoder side to transmit the audio signal to a decoder side.

The third processing module 1303 is configured to obtain a quantized value of the target spectrum value based on the target spectrum value.

Optionally, the second processing module 1302 is configured to: determine, based on the psychoacoustic spectrum envelope coefficient of the sub-band, a psychoacoustic spectrum for masking a spectrum of the audio signal; obtain, from a spectrum value of the audio signal, a to-be-determined spectrum value that is in the sub-band and that is not masked by the psychoacoustic spectrum; and determine, based on the to-be-determined spectrum value, the target spectrum value that needs to be quantized in the sub-band.

Optionally, the second processing module 1302 is configured to: obtain a second total quantity of bits consumed by the to-be-determined spectrum value in the encoded frame; when the second total quantity of bits is less than or equal to the quantity of available bits of each frame of signal, determine the to-be-determined spectrum value as the target spectrum value; and when the second total quantity of bits is greater than the quantity of available bits of each frame of signal, adjust the psychoacoustic spectrum envelope coefficient of the sub-band, and determine, based on an adjusted psychoacoustic spectrum envelope coefficient, a second total quantity of bits consumed by the to-be-determined spectrum value in the encoded frame, until the second total quantity of bits that is consumed by the to-be-determined spectrum value in the encoded frame and that is determined based on the adjusted psychoacoustic spectrum envelope coefficient is less than or equal to the quantity of available bits of each frame of signal; and determine the to-be-determined spectrum value as the target spectrum value. The adjusting the psychoacoustic spectrum envelope coefficient of the sub-band, and determining, based on an adjusted psychoacoustic spectrum envelope coefficient, a second total quantity of bits consumed by the to-be-determined spectrum value in the encoded frame includes: adjusting the psychoacoustic spectrum envelope coefficient of the sub-band in the audio signal in a first adjustment manner; updating the to-be-determined spectrum value based on the adjusted psychoacoustic spectrum envelope coefficient; and obtaining, based on an updated to-be-determined spectrum value, the second total quantity of bits consumed by the updated to-be-determined spectrum value in the encoded frame.

Optionally, the first adjustment manner is obtained based on the target bit depth.

Optionally, the first adjustment manner indicates to increase the psychoacoustic spectrum envelope coefficient of the sub-band in the audio signal when the second total quantity of bits is greater than the quantity of available bits of each frame of signal.

Optionally, the first adjustment manner indicates to adjust a psychoacoustic spectrum envelope coefficient of a second sub-band in the audio signal after adjustment of a psychoacoustic spectrum envelope coefficient of a first sub-band in the audio signal is completed, and a frequency of the first sub-band is higher than a frequency of the second sub-band.

Optionally, the second processing module 1302 is configured to: quantize the to-be-determined spectrum value based on the psychoacoustic spectrum envelope coefficient of the sub-band to obtain a quantized value of the to-be-determined spectrum value; and obtain a quantity of bits consumed by the encoder side to encode each quantized value of each frame of signal to obtain the second total quantity of bits.

Optionally, the second processing module 1302 is configured to: estimate, based on the psychoacoustic spectrum envelope coefficient of the sub-band, a third total quantity of bits consumed by the to-be-determined spectrum value in the encoded frame; when a difference between the third total quantity of bits and the quantity of available bits of each frame of signal falls within a first threshold range, determine to execute a process of obtaining the second total quantity of bits consumed by the to-be-determined spectrum value in the encoded frame; and when the difference between the third total quantity of bits and the quantity of available bits of each frame of signal is outside of the first threshold range, adjust the psychoacoustic spectrum envelope coefficient of the sub-band, and determine, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determine to execute the process of obtaining the second total quantity of bits consumed by the to-be-determined spectrum value in the encoded frame. The adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame includes: adjusting the psychoacoustic spectrum envelope coefficient of the sub-band in the audio signal in a second adjustment manner; updating the to-be-determined spectrum value based on the adjusted psychoacoustic spectrum envelope coefficient; and obtaining, based on an updated to-be-determined spectrum value, the third total quantity of bits consumed by the updated to-be-determined spectrum value in the encoded frame.

Optionally, the second processing module 1302 is configured to: estimate, based on the psychoacoustic spectrum envelope coefficient of the sub-band, a third total quantity of bits consumed by the to-be-determined spectrum value in the encoded frame; when a difference between the third total quantity of bits and the quantity of available bits of each frame of signal falls within a first threshold range, determine the to-be-determined spectrum value as the target spectrum value; and when the difference between the third total quantity of bits and the quantity of available bits of each frame of signal is outside of the first threshold range, adjust the psychoacoustic spectrum envelope coefficient of the sub-band, and determine, based on an adjusted psychoacoustic spectrum envelope coefficient, a third total quantity of bits consumed by the to-be-determined spectrum value in the encoded frame, until a difference between the third total quantity of bits that is consumed by the to-be-determined spectrum value in the encoded frame and that is determined based on the adjusted psychoacoustic spectrum envelope coefficient and the quantity of available bits of each frame of signal falls within the first threshold range; and determine the to-be-determined spectrum value as the target spectrum value. The adjusting the psychoacoustic spectrum envelope coefficient of the sub-band, and determining, based on an adjusted psychoacoustic spectrum envelope coefficient, a third total quantity of bits consumed by the to-be-determined spectrum value in the encoded frame includes: adjusting the psychoacoustic spectrum envelope coefficient of the sub-band in the audio signal in a second adjustment manner; updating the to-be-determined spectrum value based on the adjusted psychoacoustic spectrum envelope coefficient; and obtaining, based on an updated to-be-determined spectrum value, the third total quantity of bits consumed by the updated to-be-determined spectrum value in the encoded frame.

Optionally, the second adjustment manner is obtained based on the target bit depth.

Optionally, the second adjustment manner indicates to increase the psychoacoustic spectrum envelope coefficient of the sub-band in the audio signal when the third total quantity of bits is greater than the quantity of available bits of each frame of signal, or decrease the psychoacoustic spectrum envelope coefficient of the sub-band in the audio signal when the third total quantity of bits is less than the quantity of available bits of each frame of signal.

Optionally, the second adjustment manner indicates to adjust a psychoacoustic spectrum envelope coefficient of a fourth sub-band in the audio signal after adjustment of a psychoacoustic spectrum envelope coefficient of a third sub-band in the audio signal is completed, and a frequency of the third sub-band is higher than a frequency of the fourth sub-band.

Optionally, the second processing module 1302 is configured to: obtain, based on the psychoacoustic spectrum envelope coefficient of the sub-band, an average quantity of bits consumed by each spectrum value in the sub-band; obtain, based on the average quantity of bits of the sub-band and a total quantity of spectrum values included in the sub-band, a fourth total quantity of bits consumed by the spectrum value in the sub-band; and obtain the third total quantity of bits based on the fourth total quantity of bits consumed by the sub-band.

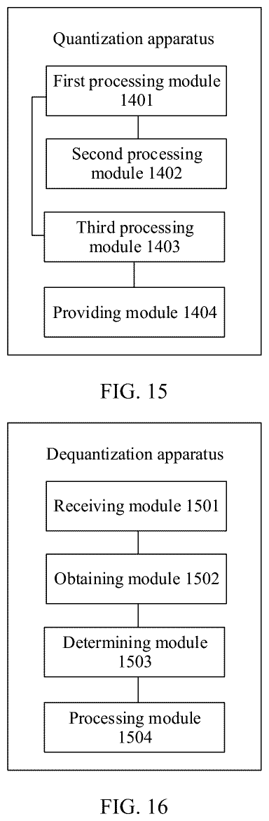

An embodiment of the present disclosure further provides another quantization apparatus. The quantization apparatus is used in an encoder side. As shown in FIG. 15, the quantization apparatus includes a first processing module 1401, a second processing module 1402, a third processing module 1403, and a providing module 1404.

The first processing module 1401 is configured to: when a first total quantity of bits consumed by a target spectrum value in an encoded frame is less than a quantity of available bits of each frame of signal, determine, based on an importance degree of information represented by a spectrum value of an audio signal, a residual spectrum value that needs to be quantized in other spectrum values, where the other spectrum values are spectrum values other than the target spectrum value in spectrum values of the audio signal.

The second processing module 1402 is configured to obtain a quantized value of the residual spectrum value based on the residual spectrum value.

The third processing module 1403 is configured to obtain quantization indication information of the residual spectrum value based on the residual spectrum value, where the quantization indication information indicates a manner of dequantizing the residual spectrum value.

The providing module 1404 is configured to provide the quantization indication information for a decoder side.

Optionally, the importance degree is indicated by a scale factor of a sub-band on which a frequency to which the spectrum value belongs is located.

Optionally, the first processing module 1401 is configured to: determine, in all sub-bands of the audio signal, a reference sub-band having a largest scale factor; determine, based on a distance from each sub-band other than the reference sub-band to the reference sub-band, weight of another spectrum value of the sub-band to be the residual spectrum value; and determine, in descending order of the weights, whether an another spectrum value of a corresponding sub-band is the residual spectrum value until a difference between a fifth total quantity of bits consumed by the target spectrum value and all the residual spectrum value in the encoded frame and the quantity of available bits of each frame of signal falls within a second threshold range, where when the another spectrum value of a sub-band is used as the residual spectrum value, if the fifth total quantity of bits consumed by the target spectrum value and all the determined residual spectrum values in the encoded frame is greater than the quantity of available bits of each frame of signal, neither the another spectrum value of the sub-band nor another spectrum value of another sub-band whose weight is less than or equal to a weight of the sub-band can be used as the residual spectrum value.

Optionally, a weight of any sub-band is inversely correlated with a distance from the any sub-band to the reference sub-band.

Optionally, a weight of a sub-band is further obtained based on a condition in which the sub-band is masked by a psychoacoustic spectrum, and a weight of a sub-band masked by the psychoacoustic spectrum is greater than a weight of a sub-band not masked by the psychoacoustic spectrum.

Optionally, the third processing module 1403 is configured to: perform rounding processing on the residual spectrum value; and determine, based on a residual spectrum value on which rounding processing is performed, a quantization manner for quantizing the residual spectrum value, to obtain the quantization indication information.

Optionally, the target spectrum value is determined according to the quantization method in any design in the first aspect.

An embodiment of the present disclosure further provides a dequantization apparatus. The dequantization apparatus is used in a decoder side. As shown in FIG. 16, the dequantization apparatus includes a receiving module 1501, an obtaining module 1502, a determining module 1503, and a processing module 1504.

The receiving module 1501 is configured to receive an encoded bitstream provided by an encoder side.

The obtaining module 1502 is configured to obtain, based on the encoded bitstream, an importance degree of information represented by a spectrum value of an audio signal.

The determining module 1503 is configured to determine, based on the importance degree, a code value and quantization indication information of a residual spectrum value in the encoded bitstream, where the quantization indication information indicates a manner of dequantizing the residual spectrum value by the encoder side.

The processing module 1504 is configured to perform a dequantization operation on the code value of the residual spectrum value based on the quantization indication information of the residual spectrum value, to obtain a dequantized code value.

Optionally, the importance degree is indicated by a scale factor of a sub-band on which a frequency to which the spectrum value belongs is located, and the scale factor of the sub-band is obtained by decoding the encoded bitstream.

Optionally, the determining module 1503 is configured to: determine, in all sub-bands of the audio signal, a reference sub-band having a largest scale factor; and determine a code value and quantization indication information of a residual spectrum value of a sub-band other than the reference sub-band in the encoded bitstream based on a distance from the sub-band other than the reference sub-band to the reference sub-band.

Optionally, when a distance from a first sub-band to the reference sub-band is shorter than a distance from a second sub-band to the reference sub-band, a code value of a residual spectrum value of the first sub-band is before a code value of a residual spectrum value of the second sub-band, and quantization indication information of the residual spectrum value of the first sub-band is before quantization indication information of the residual spectrum value of the second sub-band.

Optionally, locations of the code value and the quantization indication information of the residual spectrum value of each sub-band in the encoded bitstream are further obtained based on a condition in which the sub-band is masked by a psychoacoustic spectrum, a code value of a residual spectrum value of a sub-band masked by the psychoacoustic spectrum is before a code value of a residual spectrum value of a sub-band not masked by the psychoacoustic spectrum, quantization indication information of the residual spectrum value of the sub-band masked by the psychoacoustic spectrum is before quantization indication information of the residual spectrum value of the sub-band not masked by the psychoacoustic spectrum, and the condition in which the sub-band is masked by the psychoacoustic spectrum is obtained based on the encoded bitstream.

Optionally, the processing module 1504 is configured to: determine, based on the quantization indication information of the residual spectrum value, an offset value for performing a dequantization operation on the residual spectrum value; and perform the dequantization operation based on the code value of the residual spectrum value and the offset value, to obtain the dequantized code value.

In conclusion, in the quantization apparatus and the dequantization apparatus provided in embodiments of the present disclosure, when the first total quantity of bits consumed by the target spectrum value in the encoded frame is less than the quantity of available bits of each frame of signal, the residual spectrum value that needs to be quantized is determined from another spectrum value based on the importance of information represented by the spectrum value of the audio signal, and the quantized value of the residual spectrum value is obtained based on the residual spectrum value. This can effectively use a remaining bit, maintain a bit rate of each frame in a constant state based on the target bit rate, improve stability of the bit rate in a transmission process, and further improve anti-interference performance of the encoded bitstream for sending the audio signal.

An embodiment of the present disclosure provides a computer device. The computer device includes a memory and a processor. The memory stores program instructions, and the processor runs the program instructions to perform the method provided in embodiments of the present disclosure. For example, the following process is performed: obtaining a psychoacoustic spectrum envelope coefficient of each sub-band based on a scale factor of each sub-band and a target bit depth for encoding an audio signal; determining, based on the psychoacoustic spectrum envelope coefficient of the sub-band, a target spectrum value that needs to be quantized in the sub-band, where a first total quantity of bits consumed by the target spectrum value in an encoded frame is less than or equal to a quantity of available bits of each frame of signal, and the quantity of available bits is determined based on a target bit rate that can be used by an encoder side to transmit the audio signal to a decoder side; and obtaining a quantized value of the target spectrum value based on the target spectrum value. In addition, for an implementation process in which the computer device executes the program instructions in the memory to perform steps of the method provided in embodiments of the present disclosure, refer to corresponding descriptions in the foregoing method embodiment. Optionally, FIG. 4 is a diagram of a structure of a computer device according to an embodiment of the present disclosure.

An embodiment of the present disclosure further provides a computer-readable storage medium. The computer-readable storage medium is a non-volatile computer-readable storage medium. The computer-readable storage medium includes program instructions. When the program instructions are run on a computer device, the computer device is enabled to perform the method provided in embodiments of the present disclosure.

An embodiment of the present disclosure further provides a computer program product including instructions. When the computer program product runs on a computer, the computer is enabled to perform the method provided in embodiments of the present disclosure.

It should be understood that “at least one” mentioned in this specification refers to one or more, and “a plurality of” refers to two or more. In the descriptions of embodiments the present disclosure, unless otherwise stated, “/” means “or”. For example, A/B may represent A or B. A term “and/or” in this specification describes only an association relationship between associated objects and indicates that there may be three relationships. For example, A and/or B may represent the following three cases: Only A exists, both A and B exist, and only B exists. In addition, to clearly describe the technical solutions in embodiments of the present disclosure, terms such as “first” and “second” are used in embodiments of the present disclosure to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of the present disclosure are used under authorization by the user or full authorization by all parties, and capturing, use, and processing of related data need to conform to related laws, regulations, and standards of related countries and regions. For example, the audio signal related in embodiments of the present disclosure is obtained under full authorization.

The foregoing descriptions are merely embodiments of the present disclosure, but are not intended to limit the present disclosure. Any modification, equivalent replacement, or improvement made without departing from the principle of the present disclosure should fall within the protection scope of the present disclosure.

What is claimed is:

1. A quantization method implemented by an encoder, comprising:
when a total quantity of bits consumed by a target spectrum value in an encoded frame is less than a quantity of available bits of each frame of signal, determining, based on an importance degree of information represented by a spectrum value of an audio signal, a residual spectrum value that needs to be quantized in other spectrum values, wherein the other spectrum values are spectrum values other than the target spectrum value in spectrum values of the audio signal;
obtaining a quantized value of the residual spectrum value based on the residual spectrum value;
obtaining quantization indication information of the residual spectrum value based on the residual spectrum value, wherein the quantization indication information indicates a manner of dequantizing the residual spectrum value; and
providing the quantization indication information for a decoder.

2. The method according to claim 1, wherein the importance degree is indicated by a scale factor of a sub-band on which a frequency to which the spectrum value belongs is located.

3. The method according to claim 2, wherein the determining, based on the importance degree of information represented by the spectrum value of the audio signal, a residual spectrum value that needs to be quantized in other spectrum values comprises:
determining, in all sub-bands of the audio signal, a reference sub-band having a largest scale factor;
determining, based on a distance from each sub-band other than the reference sub-band to the reference sub-band, weight of another spectrum value of the sub-band to be the residual spectrum value; and
determining, in descending order of the weights, whether an another spectrum value of a corresponding sub-band is the residual spectrum value until a difference between a total quantity of bits consumed by the target spectrum value and all the residual spectrum value in the encoded frame and the quantity of available bits of each frame of signal falls within a second threshold range, wherein
when the another spectrum value of a sub-band is used as the residual spectrum value, and the total quantity of bits consumed by the target spectrum value and all the determined residual spectrum value in the encoded frame are greater than the quantity of available bits of each frame of signal, neither the another spectrum value of the sub-band nor another spectrum value of another sub-band whose weight is less than or equal to a weight of the sub-band can be used as the residual spectrum value.

4. The method according to claim 3, wherein a weight of any sub-band is inversely correlated with a distance from the any sub-band to the reference sub-band.

5. The method according to claim 3, wherein a weight of a sub-band masked by a psychoacoustic spectrum is greater than a weight of a sub-band not masked by the psychoacoustic spectrum.

6. The method according to claim 1, wherein the obtaining quantization indication information of the residual spectrum value based on the residual spectrum value comprises:
performing rounding processing on the residual spectrum value; and
determining, based on a residual spectrum value on which rounding processing is performed, a quantization manner for quantizing the residual spectrum value, to obtain the quantization indication information.

7. The method according to claim 1, wherein the target spectrum value is determined according to following steps:
obtaining a psychoacoustic spectrum envelope coefficient of each sub-band based on a scale factor of each sub-band and a target bit depth for encoding the audio signal;
determining, based on the psychoacoustic spectrum envelope coefficient of the sub-band, the target spectrum value in the sub-band, wherein the total quantity of bits consumed by the target spectrum value in an encoded frame is less than or equal to a quantity of available bits of each frame of signal, and the quantity of available bits is determined based on a target bit rate that can be used by the encoder to transmit the audio signal to the decoder.

8. A dequantization method implemented by a decoder, comprising:
receiving an encoded bitstream provided by an encoder;
obtaining, based on the encoded bitstream, an importance degree of information represented by a spectrum value of an audio signal;
determining, based on the importance degree, a code value and quantization indication information of a residual spectrum value in the encoded bitstream, wherein the quantization indication information indicates a manner of dequantizing the residual spectrum value; and
performing a dequantization operation on the code value of the residual spectrum value based on the quantization indication information of the residual spectrum value, to obtain a dequantized code value.

9. The method according to claim 8, wherein the importance degree is indicated by a scale factor of a sub-band on which a frequency to which the spectrum value belongs is located, and the scale factor of the sub-band is obtained by decoding the encoded bitstream.

10. The method according to claim 8, wherein the determining, based on the importance degree, the code value and quantization indication information of the residual spectrum value in the encoded bitstream comprises:
determining, in all sub-bands of the audio signal, a reference sub-band having a largest scale factor; and
determining a code value and quantization indication information of a residual spectrum value of a sub-band other than the reference sub-band in the encoded bitstream based on a distance from the sub-band other than the reference sub-band to the reference sub-band.

11. The method according to claim 10, wherein when a distance from a first sub-band to the reference sub-band is shorter than a distance from a second sub-band to the reference sub-band, a code value of a residual spectrum value of the first sub-band is before a code value of a residual spectrum value of the second sub-band, and quantization indication information of the residual spectrum value of the first sub-band is before quantization indication information of the residual spectrum value of the second sub-band.

12. The method according to claim 10, wherein locations of the code value and the quantization indication information of the residual spectrum value of each sub-band in the encoded bitstream are further obtained based on a condition in which the sub-band is masked by a psychoacoustic spectrum, a code value of a residual spectrum value of a sub-band masked by the psychoacoustic spectrum is before a code value of a residual spectrum value of a sub-band not masked by the psychoacoustic spectrum, quantization indication information of the residual spectrum value of the sub-band masked by the psychoacoustic spectrum is before quantization indication information of the residual spectrum value of the sub-band not masked by the psychoacoustic spectrum, and the condition in which the sub-band is masked by the psychoacoustic spectrum is obtained based on the encoded bitstream.

13. The method according to claim 8, wherein the performing the dequantization operation on the code value of the residual spectrum value based on the quantization indication information of the residual spectrum value, to obtain a dequantized code value comprises:
determining, based on the quantization indication information of the residual spectrum value, an offset value for performing the dequantization operation on the residual spectrum value; and
performing the dequantization operation based on the code value of the residual spectrum value and the offset value, to obtain the dequantized code value.

14. An apparatus, comprising:
a memory storing program instructions; and
one or more processors configured to execute the program instructions to:
when a total quantity of bits consumed by a target spectrum value in an encoded frame is less than a quantity of available bits of each frame of signal, determine, based on an importance degree of information represented by a spectrum value of an audio signal, a residual spectrum value that needs to be quantized in other spectrum values, wherein the other spectrum values are spectrum values other than the target spectrum value in spectrum values of the audio signal;
obtain a quantized value of the residual spectrum value based on the residual spectrum value;
obtain quantization indication information of the residual spectrum value based on the residual spectrum value, wherein the quantization indication information indicates a manner of dequantizing the residual spectrum value; and
provide the quantization indication information for a decoder.

15. The apparatus according to claim 14, wherein the importance degree is indicated by a scale factor of a sub-band on which a frequency to which the spectrum value belongs is located.

16. The apparatus according to claim 15, wherein the one or more processors are further configured to execute the program instructions to:
determine, in all sub-bands of the audio signal, a reference sub-band having a largest scale factor;
determine, based on a distance from each sub-band other than the reference sub-band to the reference sub-band, weight of another spectrum value of the sub-band to be the residual spectrum value; and
determine, in descending order of the weights, whether an another spectrum value of a corresponding sub-band is the residual spectrum value until a difference between a total quantity of bits consumed by the target spectrum value and all the residual spectrum value in the encoded frame and the quantity of available bits of each frame of signal falls within a second threshold range, wherein
when the another spectrum value of a sub-band is used as the residual spectrum value, and the total quantity of bits consumed by the target spectrum value and all the determined residual spectrum value in the encoded frame are greater than the quantity of available bits of each frame of signal, neither the another spectrum value of the sub-band nor another spectrum value of another sub-band whose weight is less than or equal to a weight of the sub-band can be used as the residual spectrum value.

17. An apparatus, comprising:
a memory storing program instructions; and
one or more processors configured to execute the program instructions to:
receive an encoded bitstream provided by an encoder;
obtain, based on the encoded bitstream, an importance degree of information represented by a spectrum value of an audio signal;
determine, based on the importance degree, a code value and quantization indication information of a residual spectrum value in the encoded bitstream, wherein the quantization indication information indicates a manner of dequantizing the residual spectrum value; and
perform a dequantization operation on the code value of the residual spectrum value based on the quantization indication information of the residual spectrum value, to obtain a dequantized code value.

18. The apparatus according to claim 17, wherein the importance degree is indicated by a scale factor of a sub-band on which a frequency to which the spectrum value belongs is located, and the scale factor of the sub-band is obtained by decoding the encoded bitstream.

19. The apparatus according to claim 17, wherein the one or more processors are configured to execute the program instructions to:
determine, in all sub-bands of the audio signal, a reference sub-band having a largest scale factor; and
determine a code value and quantization indication information of a residual spectrum value of a sub-band other than the reference sub-band in the encoded bitstream based on a distance from the sub-band other than the reference sub-band to the reference sub-band.

20. The apparatus according to claim 19, wherein when a distance from a first sub-band to the reference sub-band is shorter than a distance from a second sub-band to the reference sub-band, a code value of a residual spectrum value of the first sub-band is before a code value of a residual spectrum value of the second sub-band, and quantization indication information of the residual spectrum value of the first sub-band is before quantization indication information of the residual spectrum value of the second sub-band.
